(19) United States
(12) Patent Application Publication
(10) Pub. No.: US 2026/0222692 A1
(43) Pub. Date: Jul. 30, 2026

(54) AN IMAGING APPARATUS, AN IMAGE PROCESSING METHOD, AND A NON-TRANSITORY COMPUTER-READABLE MEDIUM

(71) Applicant: Sony Group Corporation, Tokyo (JP)

(72) Inventor: Takashi TSUCHIYA, Tokyo (JP)

(73) Assignee: Sony Group Corporation, Tokyo (JP)

(21) Appl. No.: 19/144,971

(22) PCT Filed: Dec. 5, 2023
(86) PCT No.: PCT/JP2023/043427

§ 371 Date: Jul. 1, 2025

(30) Foreign Application Priority Data
Jan. 11, 2023 (JP) 2023-002164

(51) Int. Cl. H04N 23/88; H04N 5/222; H04N 23/71; H04N 23/74; H04N 23/85

(52) U.S. Cl. CPC H04N 23/88; H04N 23/71; H04N 23/74; H04N 23/85; H04N 5/2224

(57) ABSTRACT

An imaging apparatus including circuitry configured to acquire an input image from an image sensor, generate information related to color conversion of the acquired input image based on a first color setting parameter determined according to at least one first light source configured to provide illumination light for the acquired input image, and a second color setting parameter determined according to at least one second light source configured to provide illumination light for the acquired input image, and initiate output of output data according to the generated information related to color conversion of the acquired input image.

### TECHNICAL FIELD

The present technology relates to an imaging apparatus, an image processing method, and a non-transitory computer-readable medium and, for example, relates to a technology that can be used in the field of video production.

### BACKGROUND ART

As a photographing technique for producing video contents such as a movie and the like, a technology in which a performer gives a performance before a so-called greenback, and thereafter a background video is composed is known.

In addition, in recent years, a photographing system that can image a performer and a background by causing a display to display a background video in a studio in which a large display is installed instead of greenback photographing and allowing a performer to give a performance before that has been developed as well and is known as a so-called virtual production, an in-camera VFX, or a light emitting diode (LED) wall virtual production.

A technology of a system photographing a performer giving a performance before a background video and objects is disclosed in the following PTL 1.

### CITATION LIST

### Patent Literature

PTL 1: U.S. Patent Application Publication No. 2020/0145644

### SUMMARY

### Technical Problem

In accordance with photographing of a performer and a background video using a camera in addition to displaying of the background video on a large display, there are advantages over greenback photographing such as no need for separate composition of a background video after photographing, and a performer or a staff member being able to give a performance and perform quality judgment by visually understanding a scene.

In addition, a large display displaying a background video can also take a role of lighting. For this reason, as lighting for photographing, light of a separate lighting device and light from a display may be used in combination, and, in some cases, only light from a display may be considered to be used as lighting.

However, a display for background video display has spectral characteristics different from lighting used in general photographing such as sunlight, LED lighting, or the like. For this reason, there are cases in which a captured video is not appropriate for color reproduction when light from a display is used for lighting.

Thus, the present disclosure proposes a technology enabling capture of a video of an appropriate shade also in a case in which a display is used as lighting.

### Solution to Problem

According to the present disclosure, there is provided an imaging apparatus that includes circuitry configured to acquire an input image from an image sensor, generate information related to color conversion of the acquired input image based on a first color setting parameter determined according to at least one first light source configured to provide illumination light for the acquired input image, and a second color setting parameter determined according to at least one second light source configured to provide illumination light for the acquired input image, and
initiate output of output data according to the generated information related to color conversion of the acquired input image.

In an environment in which lightings having different spectral characteristics are used, particularly, in a case in which a lighting device is used and a case in which a display device of which spectral characteristics are different from those of the lighting device and which displays a background video is used as a lighting device, for example, switching between color converting processes for color reproduction and the like can be performed.

Furthermore, according to the present disclosure, an image processing method includes acquiring an input image, generating information related to color conversion of the acquired input image based on a first color setting parameter determined according to at least one first light source configured to provide illumination light for the acquired input image, and a second color setting parameter determined according to at least one second light source configured to provide illumination light for the acquired input image, and outputting output data according to the generated information related to color conversion of the acquired input image.

In addition, according to the present disclosure, a non-transitory computer-readable medium is provided having embodied thereon a program, which when executed by a computer causes the computer to execute an information processing method, the method including acquiring an input image, generating information related to color conversion of the acquired input image based on a first color setting parameter determined according to at least one first light source configured to provide illumination light for the acquired input image, and a second color setting parameter determined according to at least one second light source configured to provide illumination light for the acquired input image, and outputting output data according to the generated information related to color conversion of the acquired input image.

### BRIEF DESCRIPTION OF DRAWINGS

FIG. 1 is an explanatory diagram of a photographing system according to an embodiment of the present technology.

FIG. 2 is an explanatory diagram of a background video according to a camera position of a photographing system according to an embodiment.

FIG. 3 is an explanatory diagram of a background video according to a camera position of a photographing system according to an embodiment.

FIG. 4 is an explanatory diagram of a video content producing process according to an embodiment.

FIG. 5 is a block diagram of a photographing system according to an embodiment.

FIG. 6 is a flowchart of background video generation of a photographing system according to an embodiment.

FIG. 7 is a block diagram of a photographing system using a plurality of cameras according to an embodiment.

FIG. 8 is a block diagram of an information processing device according to an embodiment.

FIG. 9 is an explanatory diagram of types of LED wall used in an embodiment.

FIG. 10 is an explanatory diagram of types of LED wall used in an embodiment.

FIG. 11 is an explanatory diagram of spectral characteristics of various lights.

FIG. 12 is a block diagram of a camera according to an embodiment.

FIG. 13 is an explanatory diagram of a color temperature and a tint.

FIG. 14 is an explanatory diagram of a process of a white balance unit of a camera according to an embodiment.

FIG. 15 is an explanatory diagram of a process of a matrix unit of a camera according to an embodiment.

FIG. 16 is an explanatory diagram of a process corresponding to an LED light as lighting according to an embodiment.

FIG. 17 is an explanatory diagram of a process corresponding to an LED wall lighting according to an embodiment.

FIG. 18 is an explanatory diagram of a process corresponding to LED light lighting and LED wall lighting according to an embodiment.

FIG. 19 is an explanatory diagram of a process of a white balance unit according to an embodiment.

FIG. 20 is an explanatory diagram of a process of a matrix unit according to an embodiment.

FIG. 21 is an explanatory diagram of a user interface according to an embodiment.

FIG. 22 is an explanatory diagram of a case in which lighting is an LED light in an embodiment.

FIG. 23 is an explanatory diagram of a case in which lighting is an LED wall in an embodiment.

FIG. 24 is an explanatory diagram of a case in which lighting includes an LED light and an LED wall in an embodiment.

FIG. 25 is a flowchart of a color conversion process according to an embodiment.

FIG. 26 is a flowchart of a process according to an operation according to an embodiment.

FIG. 27 is a flowchart of a process performed at the time of photographing according to an embodiment.

FIG. 28 is an explanatory diagram of an example of a process performed by raw development software according to an embodiment.

FIG. 29 is a flowchart of an example of a process performed by raw development software according to an embodiment.

FIG. 30 is an explanatory diagram of an example of a process performed by raw development software according to an embodiment.

FIG. 31 is a flowchart of an example of a process performed by raw development software according to an embodiment.

FIG. 32 is an explanatory diagram of an example of a process performed by raw development software according to an embodiment.

FIG. 33 is a flowchart of an example of a process performed by raw development software according to an embodiment.

FIG. 34 is an explanatory diagram of an example of a process performed by raw development software according to an embodiment.

FIG. 35 is a flowchart of an example of a process performed by raw development software according to an embodiment.

FIG. 36 is a flowchart of an example of a process for parameter correction and output performed by raw development software according to an embodiment.

### DESCRIPTION OF EMBODIMENTS

Hereinafter, an embodiment will be described in the following order.
<1. Photographing system and content production>
<2. Configuration of information processing device>
<3. Lighting form>
<4. Configuration and process example of camera>
<5. Process example using metadata and raw development software>
<6. Summing-up and modified example>

In the present disclosure, “video” or “image” includes any one of a still image and a moving image. In addition, there are cases in which “video” not only represents a state in which it is displayed on a display, and video data not in the state of being displayed in a display may be comprehensively referred to as “video”. This similarly applies also to “image”.

For example, in an embodiment, although a background video before it is displayed in a display, a captured video captured by a camera, background videos and captured videos switched between using a switch are not videos that are actually displayed but video data, and for the convenience of description, they will be denoted as “background video”, “captured video”, and the like.

### 1. Photographing System and Video Content Production

A photographing system and production of a video content to which the technology of the present disclosure can be applied will be described.

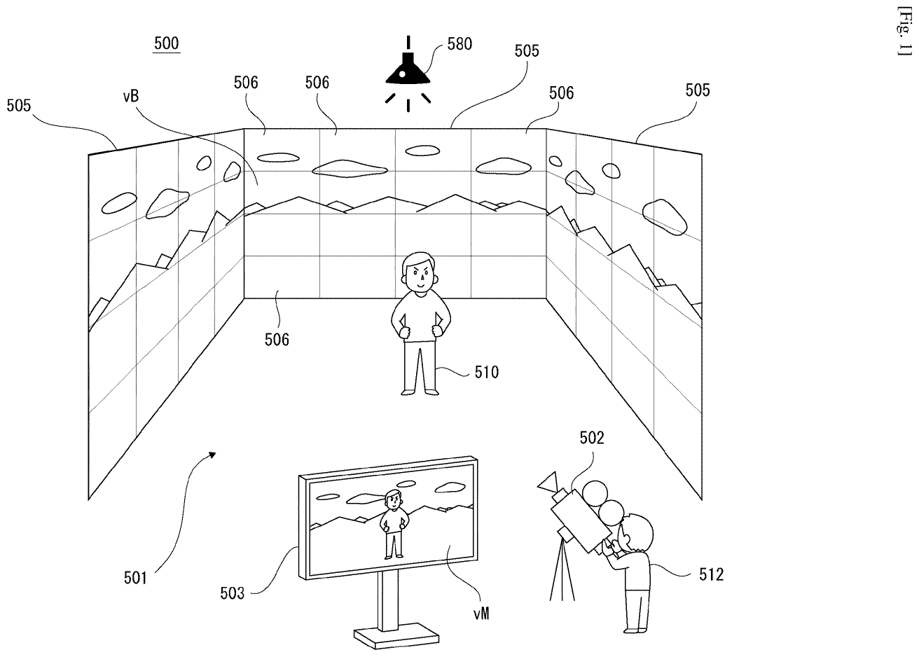

FIG. 1 schematically illustrates a photographing system 500. This photographing system 500 is a system that performs photographing as a virtual production, and a part of equipment disposed in a photographic studio is illustrated in the drawing.

In a photographic studio, a performance area 501 in which a performer 510 performs acting and other performances is disposed. On at least one of a rear face, left/right faces, and an upper face of this performance area 501, a large display device is disposed. Although a device type of display device is not particularly limited, in the drawing, as an example of a large display device, an example in which a LED wall 505 is used is illustrated.

One LED wall 505 forms a large panel due to a plurality of LED panels 506 being arranged by being horizontally and vertically connected. Although a size of the LED wall 505 described here is not particularly limited, it may be a size that is necessary as a size for displaying a background at the time of photographing a performer 510 or a sufficient size.

At required positions such as an upper side, a lateral side, or the like of the performance area 501, lights 580 of a required number are disposed, and lighting is performed for the performance area 501.

Near the performance area 501, for example, a camera 502 used for photographing a movie and other video contents is disposed. A cameraman 512 can move a position of the camera 502 and can perform operations of a photographing direction, a viewing angle, and the like thereon. It is conceivable to perform movement, an angle of view operation, and the like of the camera 502 in accordance with a remote operation. In addition, the camera 502 may automatically or autonomously perform movement and change of an angle of view. For this reason, there are also cases in which the camera 502 is mounted in a camera platform or a moving body.

A performer 510 in the performance area 501 and a video displayed on the LED wall 505 are photographed together by the camera 502. For example, in accordance with display of a landscape on the LED wall 505 as a background video vB, a video similar to that of a case in which the performer 510 is actually present at a place of the landscape and performs acting can be photographed.

Near the performance area 501, an output monitor 503 is disposed. In this output monitor 503, a video photographed by the camera 502 is displayed in real time as a monitor video vM. In accordance with this, a director or a staff member performing production of a video content can check a video that is being photographed.

In this way, the photographing system 500 photographing performance of a performer 510 having the LED wall 505 as a background in a photographic studio has various advantages over green back photographing.

For example, in the case of green back photographing, it is difficult for a performer to imagine situations of a background and a scene, which may have an influence on acting. In contrast to this, by displaying the background video vB, it becomes easy for the performer 510 to perform acting, and thus the quality of acting is improved. In addition, a director and other staff members can easily determine whether or not acting of the performer 510 matches situations of a background and a scene.

In addition, post-production after photographing becomes more efficient than that of the case of green back photographing. The reason for this is that there is a case in which so-called chromakey composition can be configured to be unnecessary and a case in which color correction and composition of reflection can be configured to be unnecessary. In addition, also in a case in which chromakey composition becomes necessary at the time of photographing, a green and blue video may be only displayed, and thus addition of a physical background screen becomes unnecessary, which is also helpful for improvement of efficiency.

In the case of green back photographing, a green shade increases in a body, clothes, and objects of a performer, and thus a correction thereof is necessary. In addition, in the case of green back photographing, in a case in which an object such as a glass, a mirror, a snow dome, or the like in which a circumferential sight is reflected is present, an image in which the video is reflected needs to be generated and composed, which is an operation requiring effort.

In contrast to this, in a case in which photographing is performed by the photographing system 500 illustrated in FIG. 1, a green shade does not increase, and thus a correction thereof is unnecessary. In addition, by displaying the background video vB, a reflection in an actual object such as a glass can be naturally captured, and thus composition of a reflected video is unnecessary.

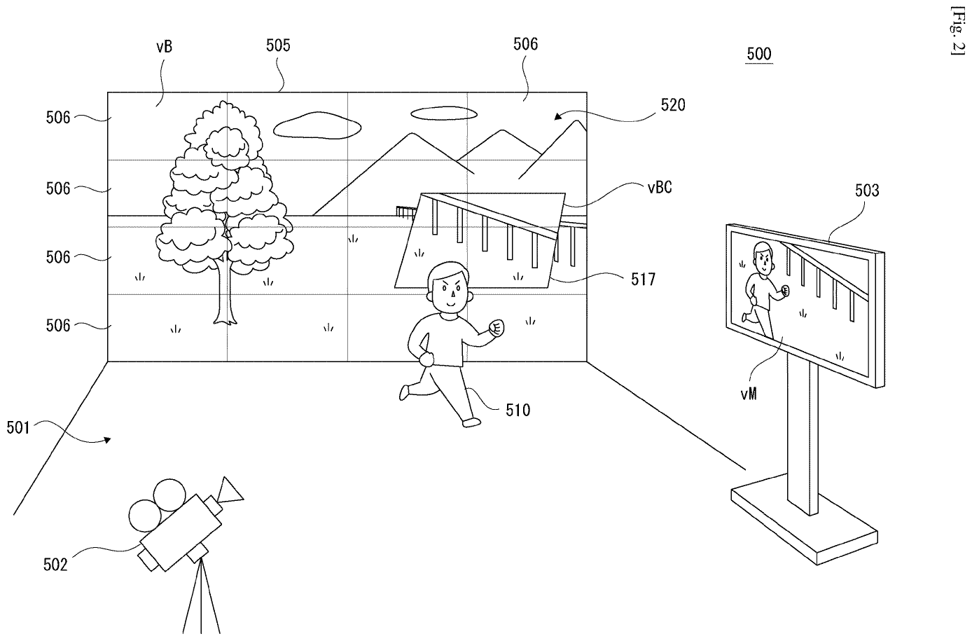

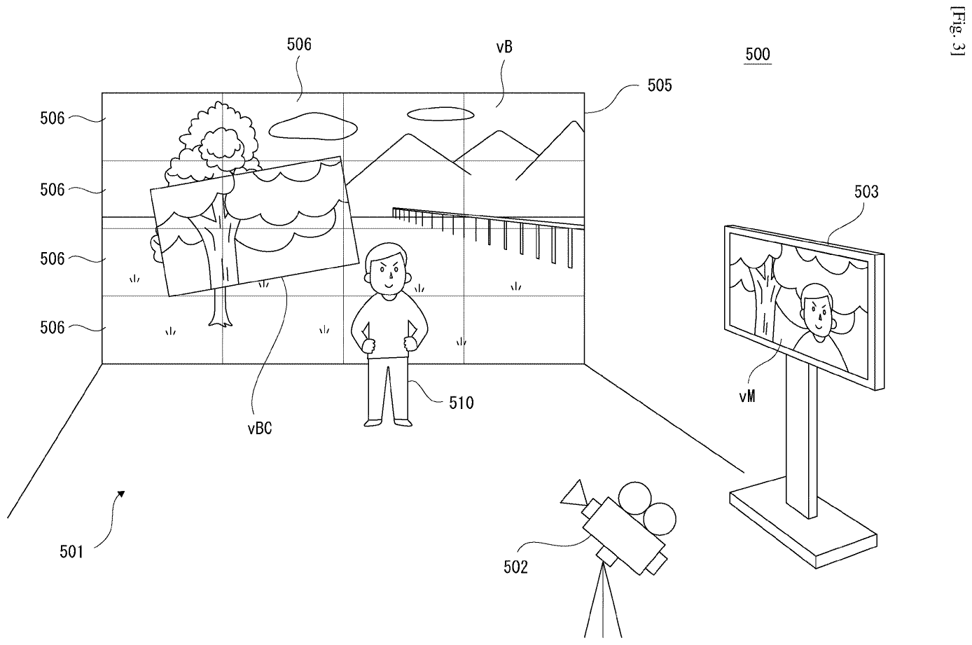

Here, the background video vB will be described with reference to FIGS. 2 and 3. Even when the background video vB is displayed on the LED wall 505 and is photographed together with a performer 510, in a case in which only the background video vB is simply displayed, the background of a captured video becomes unnatural. The reason for this is that an actually-stereoscopic background also having a depth is formed as a background video vB in a planar form.

For example, the camera 502 can photograph the performer 510 of the performance area 501 from various directions and also can perform a zoom operation. The performer 510 does not stop at one place. Then, although a visual performance of the background of the performer 510, which is actually seen, changes in accordance with a position, a photographing direction, an angle of view, and the like of the camera 502, such a change cannot be acquired in the background video vB as a planar video. Thus, the background video vB is changed such that the background including parallax has a visual performance similar to the actual visual performance.

FIG. 2 illustrates a view in which a camera 502 photographs a performer 510 from a position on a left side in the drawing, and FIG. 3 illustrates a view in which a camera 502 photographs a performer 510 from a position on a right side in the drawing. In each of the diagrams, a photographing area video vBC is illustrated inside a background video vB.

In addition, a part of the background video vB except for the photographing area video vBC will be referred to as “outer frustum, and the photographing area video vBC will be referred to as “inner frustum”.

The background video vB described here represents an entire vide displayed as a background including the photographing area video vBC (the inner frustum).

A range of this photographing area video vBC (the inner frustum) corresponds to a range that is actually photographed by the camera 502 inside the display face of the LED wall 505. The photographing area video vBC becomes a video expressing a sight seen when the position of the camera 502 is actually set as a viewpoint in correspondence with a position, a photographing direction, an angle of view, and the like of the camera 502.

More specifically, for the photographing area video vBC, three dimension (3D) background data that is a 3D model as a background is prepared, and the 3D background data is sequentially rendered on the basis of the viewpoint position of the camera 502 in real time.

In addition, actually, the range of the photographing area video vBC is a range that is slightly wider than a range photographed by the camera 502 at the time point. This is for preventing a video of an outer frustum from being reflected due to a drawing delay or avoiding an influence according to diffracted light from a video from an outer frustum when a photographed range is slightly changed in accordance with pan, tilt, zoom, or the like of the camera 502.
In this way, the video of the photographing area video vBC that has been rendered in real time in this way is composed with the video of the outer frustum. Although there is a case in which the video of the outer frustum used in the background video vB has been rendered on the basis of 3D background data in advance and a case in which the video is rendered in real time for each frame or for intermittent frames, by embedding the video of the photographing area video vBC (the inner frustum) into a part of the video of the outer frustum, an entire background video vB is generated.
In addition, although there is a case in which the video of the outer frustum is rendered for each frame similar to the inner frustum, here, a still video will be used as an example, and, in the following description, a case in which only a first frame of the video of the outer frustum is rendered will be mainly described as an example.

In accordance with this, even when the camera 502 is moved to a front/back/left/right side, or a zoom operation is performed, the background of the range photographed together with a performer 510 is photographed as a video according to a change of a viewpoint position or a field of view (FOV) accompanying actual movement of the camera 502.

As illustrated in FIGS. 2 and 3, while a monitor video vM including the performer 510 and the background is displayed in the output monitor 503, this is a photographed video. The background in this monitor video vM is a photographed area video vBC. In other words, the background included in a photographed video is a video that has been rendered in real time.

In this way, the photographing system 500 according to the embodiment not only displays the background video vB in a plane but also changes the background video vB including the photographed area video vBC in real time such that a video as in a case in which a landscape is actually photographed can be photographed.

In addition, by rendering not the entire background video vB displayed in the LED wall 505 but only a photographed area video vBC as a range reflected by the camera 502 in real time, a plan for reducing the processing load of the system may be performed.

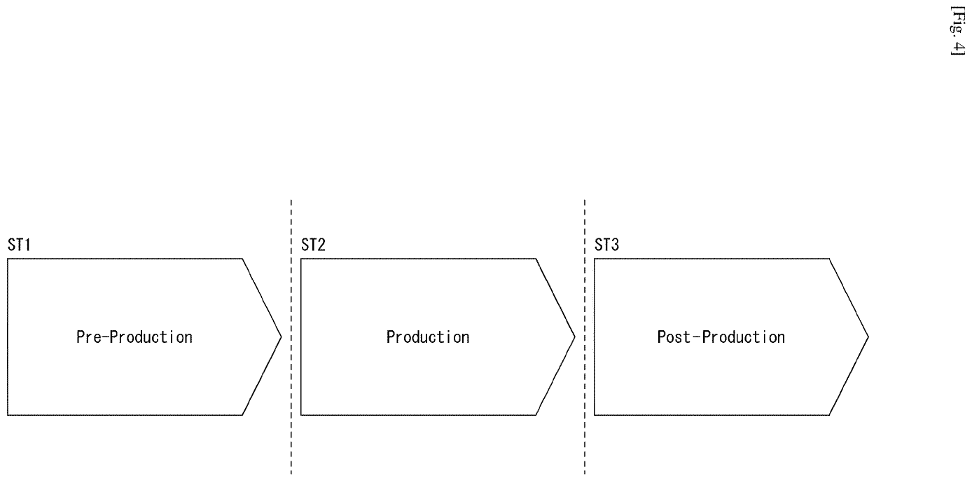

Here, as a virtual production performing photographing using the photographing system 500, a process of producing a video content will be described. As illustrated in FIG. 4, the video content producing process is largely divided into three steps. The three steps are a preproduction ST1, a production ST2, and a post-production ST3.

The preproduction ST1 is a process of producing 3D background data for displaying a background video vB. As described above, the background video vB is generated by performing rendering in real time using 3D background data at the time of photographing. For this reason, 3D background data as a 3D model is produced in advance.

Examples of a technique for producing 3D background data include full computer graphics (CG), point cloud data scanning, and photogrammetry.

The full CG is a technique for producing a 3D model using computer graphics. This technique is a technique requiring the largest number of processes and the longest time among the three techniques and is appropriately used in a case in which an unrealistic video, a video that is actually difficult to photograph, or the like is desired to be set as the background video vB.

The point cloud data scanning is a technique for generating a 3D model according to point cloud data by measuring a distance from a certain position, for example, by employing a LiDAR, photographing a 360-degrees image from the same position using the camera, and loading color data photographed by the camera on a point of which a distance has been measured by the LiDAR. According to this technique, when compared with full CG, a 3D model can be produced in a relatively short time. In addition, a 3D model having high accuracy can be produced more easily than in the case of the photogrammetry.

The photogrammetry is a technology of photograph measurement acquiring a dimension and a shape by analyzing parallax information from a two-dimensional image acquired by photographing an object from a plurality of viewpoints. According to this technology, 3D model production can be performed in a short time.

In addition, in generation of 3D data using the photogrammetry, point cloud information acquired by the LiDAR may be used.

In the preproduction ST1, for example, by using such a technique, a 3D model that becomes 3D background data is produced. It is apparent that the techniques described above may be used in combination. For example, parts of 3D models produced using the point cloud data scanning and the photogrammetry may be produced using CG and composed or the like.

The production ST2 is a process of performing photographing in the photographic studio as illustrated in FIG. 1. As element technologies of such a case, there are real-time rendering, background display, camera tracking, lighting control, and the like.

Real-time rendering, as described in FIGS. 2 and 3, is a rendering process for acquiring a photographing area video vBC at each time point (each frame of the background video vB). This is to perform rendering at a viewpoint according to a position and the like of the camera 502 at each time point for 3D background data produced in the preproduction ST1.

By performing real-time rendering in this way, a background video vB of each frame including the photographing area video vBC is generated and is displayed in the LED wall 505.

The camera tracking is performed for acquiring photographing information using the camera 502, and position information, a photographing direction, an angle of view, and the like of each time point of the camera 502 are tracked. By providing photographing information including these for a rendering engine in association with each frame, real-time rendering according to a viewpoint position and the like of the camera 502 can be performed.

The photographing information is information that is associated with or in correspondence with a video as metadata. The photographing information is assumed to include position information, a camera direction, an angle of view, a focal distance, an F value (a diaphragm value), a shutter speed, lens information, and the like of the camera 502 at each frame timing.

In the lighting control, by controlling a lighting state in the photographing system 500, more specifically, a light quantity, a light emission color, a lighting direction, and the like of the light 580 are controlled. For example, lighting control according to a time setting, a place setting, and the like of a scene to be photographed is performed.

The post-production ST3 represents various processes performed after photographing. For example, a correction of a video, adjustment of a video, clip editing, a video effect, and the like are performed.

As corrections of a video, color gamut conversion, color matching between a camera and materials, and the like may be performed.

As adjustment of a video, color adjustment, luminance adjustment, contrast adjustment, and the like may be performed.

As clip editing, cutting, adjustment of a sequence, adjustment of a time length, and the like may be performed.

As video effects, compositions of a CG video and a special effect video and the like may be performed.

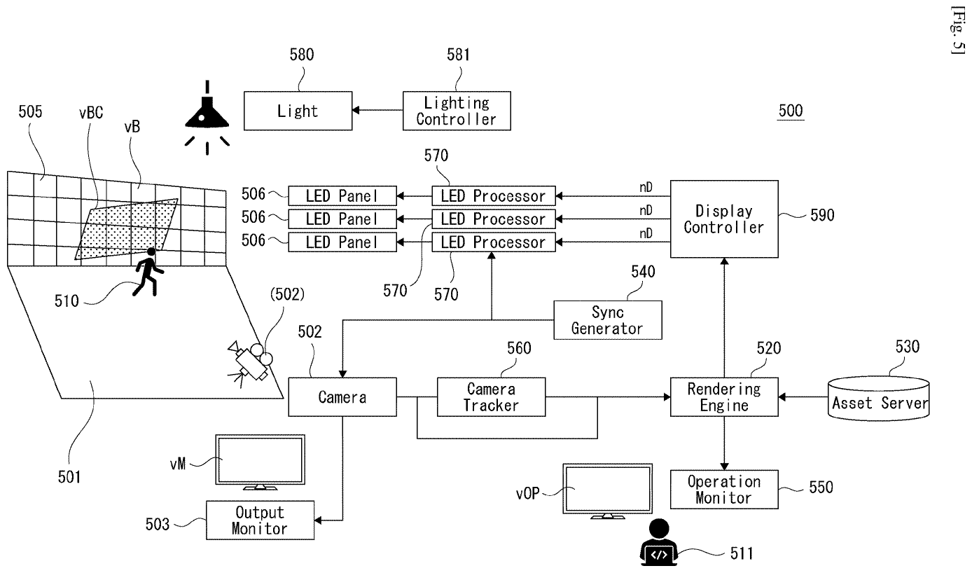

Subsequently, the configuration of the photographing system 500 used in the production ST2 will be described. FIG. 5 is a block diagram illustrating the configuration of the photographing system 500 of which an overview has been described in FIGS. 1, 2, and 3.

The photographing system 500 illustrated in FIG. 5 includes the LED wall 505 using the plurality of LED panels 506, the camera 502, the output monitor 503, and the light 580 described above. In addition, the photographing system 500, as illustrated in FIG. 5, includes a rendering engine 520, an asset server 530, a synchronization generator 540, an operation monitor 550, a camera tracker 560, LED processors 570, a lighting controller 581, and a display controller 590.

The LED processors 570 are disposed in correspondence with one or a plurality of LED panels 506 and perform video display drive of one or the plurality of LED panels 506 corresponding thereto.

The synchronization generator 540 generates a synchronization signal for taking synchronization between a frame timing of a display device according to the LED panel 506 and a frame timing of photographing according to the camera 502 and supplies the generated synchronization signal to each LED processor 570, the camera 502, and the rendering engine 520.

The camera tracker 560 generates photographing information according to the camera 502 at each frame timing and supplies the generated photographing information to the rendering engine 520. For example, the camera tracker 560 detects relative position information of the camera 502 with respect to the position of the LED wall 505 or a predetermined reference position and a photographing direction of the camera 502 as one piece of photographing information and supplies these to the rendering engine 520.

As a specific detection technique according to the camera tracker 560, there is a method in which a reflective plate is randomly arranged at the ceiling, and a position is detected from reflective light of infrared light emitted from the camera tracker 560 assembled with the camera 502 for them. In addition, as a detection technique, there is a method in which its own device position of the camera 502 is estimated using gyro information mounted in the platform of the camera 502 or the main body of the camera 502 and image recognition of a photographed video of the camera 502.

In addition, there are cases in which an angle of view, a focal distance, an F value, a shutter speed, lens information, and the like are supplied from the camera 502 to the rendering engine 520 as photographing information.

The asset server 530 is a server that stores the 3D model produced in the preproduction ST1, that is, 3D background data in a recording medium and is capable of reading the 3D model as necessary. In other words, the asset server 530 functions as a database (DB) of the 3D background data.

The rendering engine 520 performs a process of generating a background video vB to be displayed on the LED wall 505. For this reason, the rendering engine 520 reads necessary 3D background data from the asset server 530. Then, by rendering the 3D background data in a form seen from space coordinates designated in advance, the rendering engine 520 generates a video of the outer frustum used in the background video vB.

In addition, the rendering engine 520 identifies a visual point position and the like for the 3D background data using the photographing information supplied from the camera tracker 560 or the camera 502 and performs rendering of the photographing area video vBC (the inner frustum).

Furthermore, the rendering engine 520 composes the photographing area video vBC dynamically changing in accordance with movement of the camera 502 with the outer frustum, thereby generating a background video vB as video data of one frame. Then, the rendering engine 520 transmits the generated video data of one frame to the display controller 590.

The display controller 590 generates a divisional video signal nD acquired by dividing video data of one frame in a video part to be displayed in each LED panel 506 and transmits the divisional video signal nD to each LED panel 506. At this time, the display controller 590 may perform calibration according to an individual difference/manufacturing error and the like of color development and the like between display units.

In addition, without disposing the display controller 590, such a process may be performed by the rendering engine 520. In other words, the rendering engine 520 may generate a divisional video signal nD, perform calibration, and transmit the divisional video signal nD to each LED panel 506.

Each LED processor 570 drives the LED panel 506 on the basis of the received divisional video signal nD, whereby an entire background video vB is displayed on the LED wall 505. In the background video vB, a photographing area video vBC rendered in accordance with a position and the like of the camera 502 at the time point is included.

The camera 502 can photograph a performance of a performer 510 including the background video vB displayed on the LED wall 505 in this way. A video acquired through photographing of the camera 502 is recorded in a recording medium disposed inside of the camera 502 or in an external recording device not illustrated in the drawing, is supplied to the output monitor 503 in real time, and is displayed as a monitor video vM.

In the operation monitor 550, an operation image vOP for controlling the rendering engine 520 is displayed. An engineer 511 can perform necessary settings and operations relating to rendering of the background video vB while viewing the operation image vOP.

The lighting controller 581 controls a light emission intensity, a light emission color, an emission direction, and the like of the light 580. The lighting controller 581, for example, may perform control of the light 580 asynchronously with the rendering engine 520 or may perform control in synchronization with photographing information and a rendering process. For this reason, in accordance with an instruction from the rendering engine 520, a master controller not illustrated in the drawing, or the like, the lighting controller 581 may perform light emission control. In addition, control of the light 580 may be performed from the rendering engine 520.

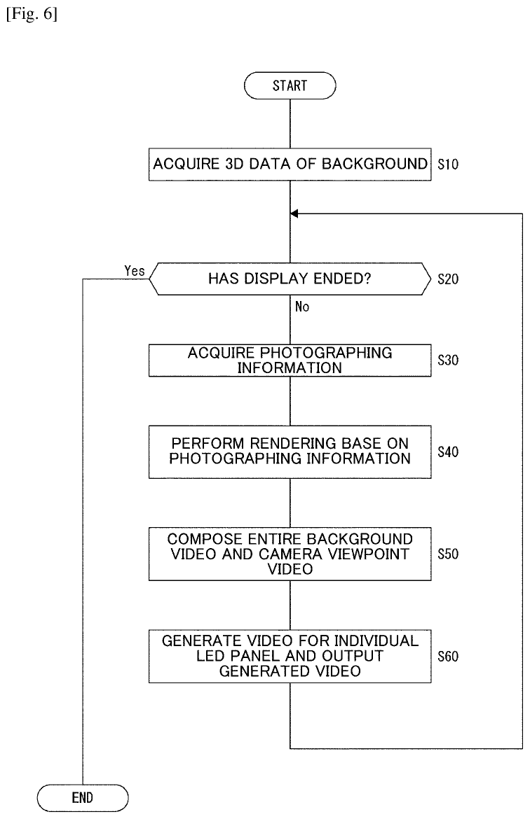

An example of the process of the rendering engine 520 in the photographing system 500 of such a configuration is illustrated in FIG. 6.

The rendering engine 520 reads 3D background data used this time from the asset server 530 and expands the read 3D background data used at this time in an internal work area in Step S10.

In this stage, there are cases in which a video used as an outer frustum is generated.

Thereafter, the rendering engine 520 repeats the processes of Step S30 to Step S60 until display end of the background video vB based on the read 3D background data is judged in Step S20.

In Step S30, the rendering engine 520 acquires photographing information from the camera tracker 560 or the camera 502. In accordance with this, a position and a state of the camera 502 reflected in a current frame are checked.

In Step S40, the rendering engine 520 performs rendering on the basis of the photographing information. In other words, on the basis of a position, a photographing direction, an angle of view, and the like of the camera 502 reflected in the current frame, a viewpoint position for the 3D background data is identified, and rendering is performed. At this time, a video process in which a focal distance, an F value, a shutter speed, lens information, and the like are reflected may be performed. In accordance with this rendering, video data as a photographing area video vBC (the inner frustum) can be acquired. The outer frustum may be generated as a fixed video in advance in Step S10 or may be generated for each frame in Step S40.

In Step S50, the rendering engine 520 performs a process of composing an outer frustum that is an entire background video with a video in which a viewpoint position of the camera 502 is reflected, that is, a photographing area video vBC. For example, this process is a process of composing a video generated with the viewpoint of the camera 502 reflected with a video of the entire background rendered at a certain specific reference viewpoint. In accordance with this, a background video vB of one frame displayed on the LED wall 505, that is, a background video vB including the photographing area video vBC is generated.

The process of Step S60 is performed by the rendering engine 520 or the display controller 590. In Step S60, the rendering engine 520 or the display controller 590 generates divisional video signals nD divided into videos displayed on individual LED panels 506 for the background video vB of one frame. There are cases in which calibration is performed. Then, each divisional video signal nD is transmitted to each LED processor 570.

In accordance with the process described above, at each frame timing, the background video vB including the photographing area video vBC captured by the camera 502 is displayed on the LED wall 505.

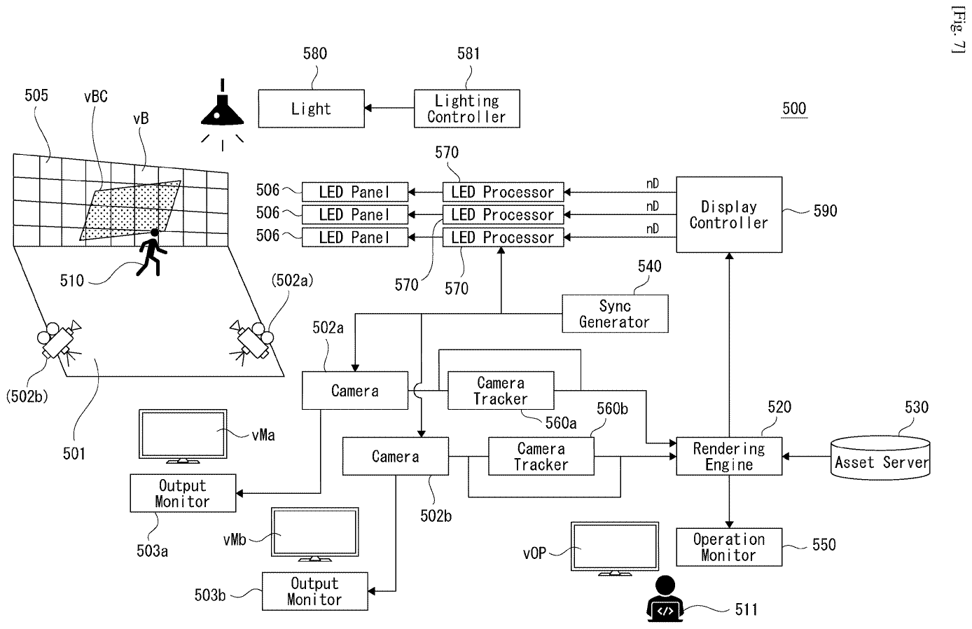

Although only one camera 502 is illustrated in FIG. 5, photographing may be performed using a plurality of cameras 502. FIG. 7 illustrates a configuration example of a case in which a plurality of cameras 502a and 502b are used. Each of the cameras 502a and 502b is configured to be able to independently perform photographing in a performance area 501. In addition, synchronization of the cameras 502a and 502b and the LED processors 570 is maintained by the synchronization generator 540.

Output monitors 503a and 503b are disposed in correspondence with the cameras 502a and 502b and are configured to display videos respectively photographed by the corresponding cameras 502a and 502b as monitor videos vMa and vMb.

In addition, camera trackers 560a and 560b are disposed in correspondence with the cameras 502a and 502b and detect positions and photographing directions of the cameras 502a and 502b corresponding thereto. Photographing information from the camera 502a and the camera tracker 560a and photographing information from the camera 502b and the camera tracker 560b are transmitted to the rendering engine 520.

The rendering engine 520 can perform rendering for acquiring the background video vB of each frame using photographing information of one or both of the camera 502a side and the camera 502b side.

Although an example in which two cameras 502a and 502b are used is illustrated in FIG. 7, photographing can be performed using three or more cameras 502.

Here, when a photographing area video vBC (the inner frustum) corresponding to each camera 502 is rendered and displayed using photographing information using the plurality of cameras 502, there is a situation in which the photographing area videos vBC interfere with each other. For example, in the example in which two cameras 502a and 502b are used as illustrated in FIG. 7, although a photographing area video vBC corresponding to the camera 502a is illustrated, in a case in which a video of the camera 502b is used, a photographing area video vBC corresponding to the camera 502b is necessary. In that case, when the photographing area videos vBC corresponding to the cameras 502a and 502b are simply displayed, the photographing area videos interfere with each other. For this reason, a plan for displaying the photographing area videos vBC is necessary.

### 2. Configuration of Information Processing Device

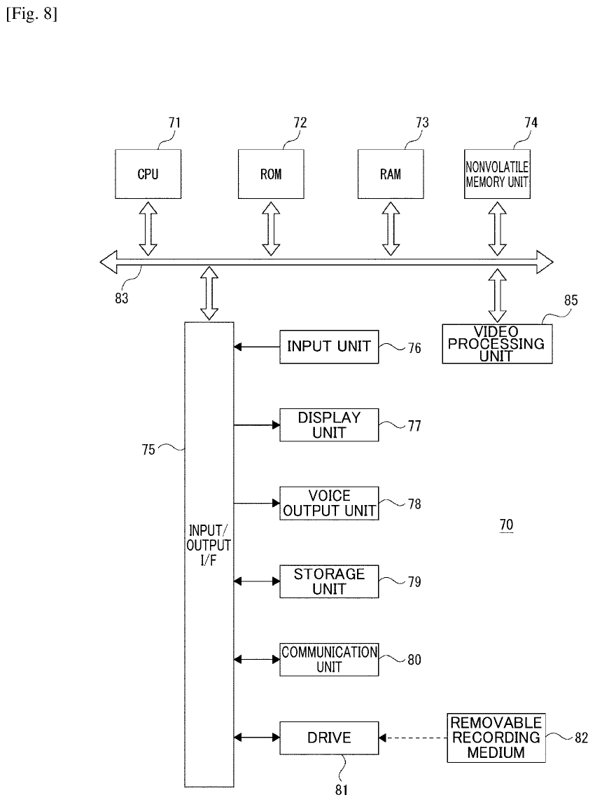

Next, a configuration example of an information processing device 70 that can be used in the preproduction ST1, the production ST2, and the post-production ST3 will be described with reference to FIG. 8.

The information processing device 70 is a computer device or the like that can perform information processing, particularly, video processing. As this information processing device 70, more specifically, a personal computer, a workstation, a portable terminal device such as a smartphone, a tablet, or the like, a video editing device, or the like is assumed. In addition, the information processing device 70 may be a computer device configured as a server apparatus or an arithmetic operation device in cloud computing.

In the case of this embodiment, more specifically, the information processing device 70 can function as a 3D model producing device that produces a 3D model in the preproduction ST1.

In addition, the information processing device 70 can function also as the rendering engine 520 configuring the photographing system 500 or the asset server 530 used in the production ST2. Furthermore, the information processing device 70 can function also as a control system, a signal processing system, and an interface system included in the camera 502.

In addition, the information processing device 70 can function also as a video editing device that performs various kinds of video processing in the post-production ST3.

A Central Processing Unit (CPU) 71 of the information processing device 70 illustrated in FIG. 8 performs various processes in accordance with a program stored in a Read Only Memory (ROM) 72 or a non-volatile memory unit 74, for example, such as an Electrically Erasable Programmable Read-Only Memory (EEPROM) or the like or a program loaded from a storage unit 79 into a Random Access Memory (RAM) 73. In the RAM 73, data and the like that are necessary for the CPU 71 to perform various processes and the like are appropriately stored.

A video processing unit 85 is configured as a processor that performs various video processes. For example, the video processing unit is formed as a processor that can perform one of a video process including a 3D model generating process, a rendering DB process, a color luminance adjusting process, and a color converting process, a video editing process, a video analyzing/detecting process, and the like or a plurality of processes.

This video processing unit 85, for example, can be realized using a CPU that is a unit separated from the CPU 71, a Graphics Processing Unit (GPU), a General-purpose computing on graphics processing unit (GPGPU), an artificial intelligence (AI) processor, and the like.

In addition, the video processing unit 85 may be provided as a function of the inside of the CPU 71.

The CPU 71, the ROM 72, the RAM 73, the non-volatile memory unit 74, and the video processing unit 85 are interconnected through a bus 83. In addition, an input/output interface 75 is connected to this bus 83.

An input unit 76 formed from an operator and an operation device is connected to the input/output interface 75. For example, as the input unit 76, various operators and various operation devices such as a keyboard, a mouse, keys, a trackball, a dial, a touch panel, a touch pad, a remote controller, and the like are assumed.

A user's operation is detected by the input unit 76, and a signal corresponding to an input operation is analyzed by the CPU 71.

As the input unit 76, a microphone is assumed as well. A voice spoken by a user can be input as operation information.

In addition, a display unit 77 formed from a Liquid Crystal Display (LCD), an organic electro-luminescence (EL) panel, or the like and a voice output unit 78 formed from a speaker or the like are integrally or separately connected to the input/output interface 75.

The display unit 77 is a display unit that performs various kinds of display and, for example, is configured using a display device disposed in a casing of the information processing device 70 or a separate display device or the like connected to the information processing device 70.

The display unit 77 performs display of various images, operation menus, icons, messages, and the like, in other words, display as a Graphical User Interface (GUI) on a display device on the basis of an instruction from the CPU 71.

A storage unit 79 configured from a Hard Disk Drive (HDD), a Solid State Drive (SSD), and the like and a communication unit 80 may be connected to the input/output interface 75.

The storage unit 79 can store various kinds of data and programs. In the storage unit 79, a DB may be configured.

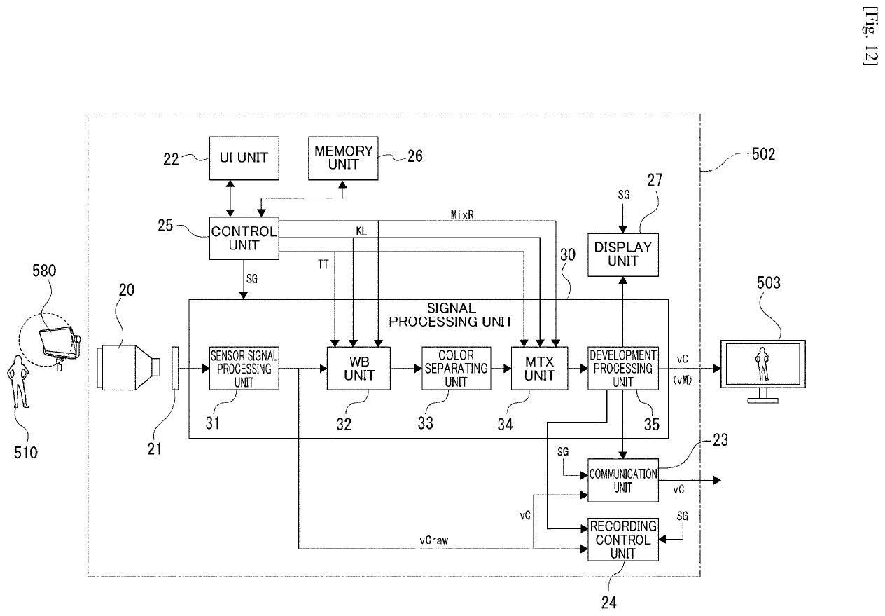

The communication unit 80 performs a communication process through a transmission line such as the Internet and communication using wired/wireless communication, bus communication, or the like with various devices such as an external DB, an editing device, and an information processing device, and the like. For example, in the case of the information processing device 70 used in the post-production ST3, an access to a DB as the asset server 530 and the like can be performed using the communication unit 80. In accordance with this, the information processing device 70 can acquire a photographing video vC (see FIG. 12 and the like) photographed by the camera 502 and accompanying metadata MT (see FIG. 30 and the like).

In addition, a drive 81 is connected to the input/output interface 75 as necessary, and a removable recording medium 82 such as a magnetic disk, an optical disc, a magneto-optical disc, a semiconductor memory, and the like are appropriately mounted.

By using the drive 81, video data, various computer programs, and the like can be read from the removable recording medium 82. Read data is stored in the storage unit 79, or a video or a voice included in the data are output to the display unit 77 and the voice output unit 78. In addition, a computer program and the like read from the removable recording medium 82 are installed in the storage unit 79 as necessary.

In this information processing device 70, for example, software for a process according to this embodiment can be installed through network communication using the communication unit 80 or the removable recording medium 82. Alternatively, this software may be stored in the ROM 72, the storage unit 79, or the like in advance.

### 3. Lighting Form

A form of lighting in the production ST2 will be described. As described above, the light 580 is present in the photographing system 500 as a lighting device. As the light 580, for example, an LED light is used.

Meanwhile, the LED wall 505 displaying the background video vB emits a video light from each LED panel 506 and thus can serve as lighting for a foreground, for example, for a performer 510.

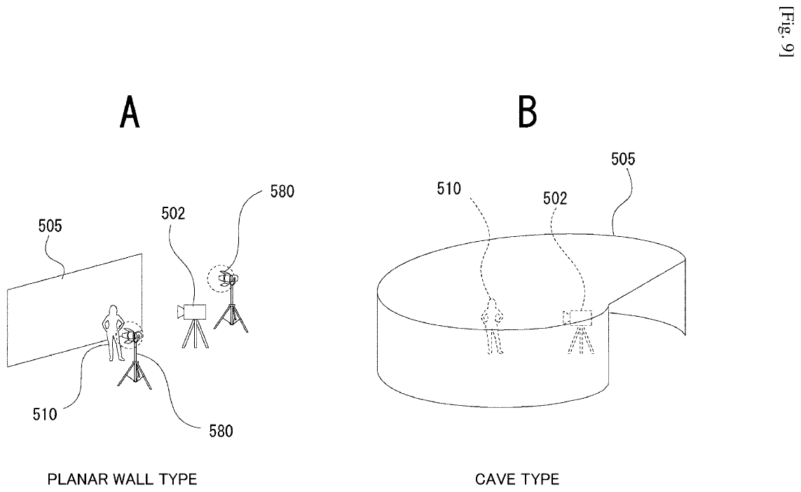

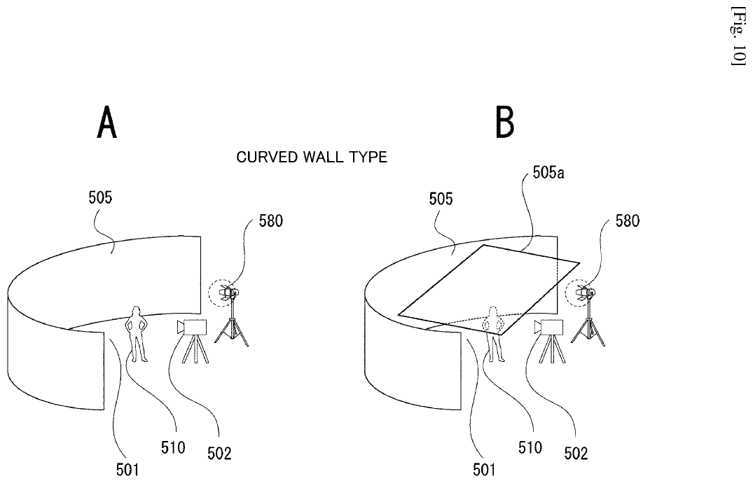

FIGS. 9A, 9B, 10A, and 10B illustrate examples of lighting forms.

FIG. 9A is a case in which the LED wall 505 is a planar wall type. In this case, it is difficult for light from the LED wall 505 to be emitted to the front face of a performer 510, and thus the light 580 may be considered to be used as lighting for the performer 510.

FIG. 9B is a case in which the LED wall 505 is a cave type. For example, there is a case in which the LED wall 505 widely covers the vicinity of a performer 510, has a ceiling, and displays a background video vB in the vicinity and on the upper side. In the case of this cave type, light from the LED wall 505 functions as sufficient lighting for the performer 510, and thus the light 580 may not be used.

FIG. 10A is a case in which the LED wall 505 is formed in a curved wall type in which a lateral side is surrounded from a rear side of a performer 510. In this case, light from the LED wall 505 can be emitted to the performer 510. For this reason, as lighting, both the light 580 and light from the LED wall 505 may be used.

In addition, for example, in the case of the curved wall type, in order to cause lighting and reflection of a landscape on objects (for example, reflection on a mirror, a glass, and the like as objects present in the performance area 501) to be similar to an actual landscape, as illustrated in FIG. 10B, as a part of the LED wall 505, an LED panel 505a having a rectangle shape may be installed at the ceiling. In addition, there case also cases in which an LED panel covering the entire ceiling, which is close to the cave type, is formed.

In addition, as illustrated in FIG. 1, not in the curved wall type but in a planar wall type, there are cases in which LED panels may be disposed on the rear side and the lateral side, and, in such cases, there are an example in which the LED panel 505a is disposed at the ceiling and an example in which an LED panel covers the entire ceiling. Also in such an LED wall 505, there are cases in which light from both the light 580 and the LED wall 505 may be used as lighting.

For example, as described above, as lighting, there are a case in which the light 580 is used, a case in which only the LED wall 505 is used, and a case in which both the light 580 and the LED wall 505 are used as lighting.

The description presented above is merely an example. Although a lighting form may be determined in accordance with a type of the LED wall 505, there are also cases in which a lighting form does not need to be determined in accordance with the type of the LED wall 505. For example, in the case of the cave-type LED wall 505, there is a case in which the light 580 is used, and, in the case of the LED wall 505 of the planar wall type, that is a case in which the LED wall 505 is used as lighting.

Meanwhile, in the photographing system 500, for example, as illustrated in FIG. 9A, the light 580 is assumed to be used as lighting, and, in photographing video data (a photographing video vC to be described below) photographed by the camera 502, there is no problem in color reproduction of a video of a photographed part of the performer 510 and the like.

The reason for this is that the light 580 for lighting (for example, an LED light) has spectral characteristics close to natural light, and natural color reproduction can be acquired. In other words, the reason for this is that, generally, the camera 502 is designed such that natural color reproduction can be acquired in a case in which lighting is performed using the light 580.

The LED wall 505 used for displaying the background video vB has spectral characteristics that are largely different from natural light.

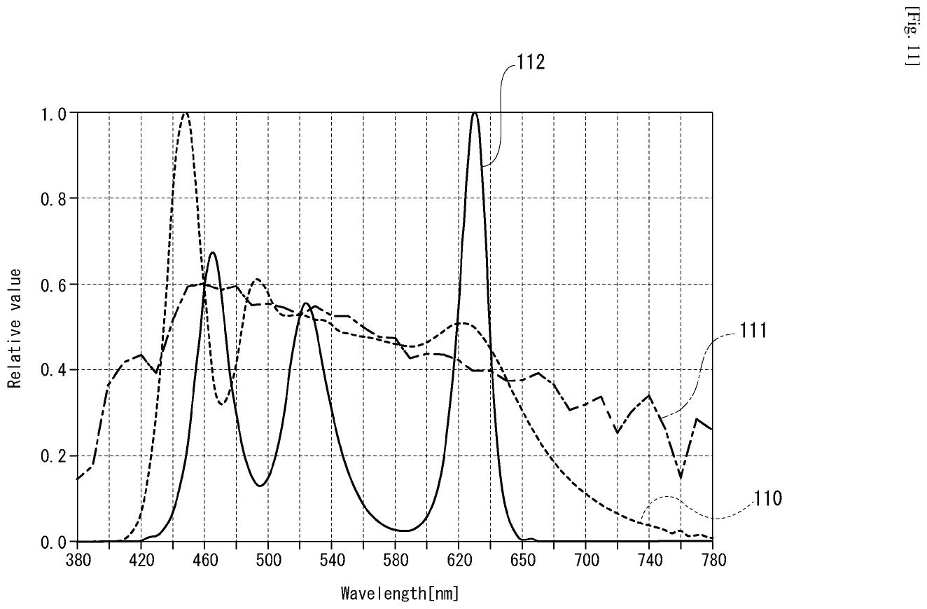

In FIG. 11, spectral characteristics of natural light (sunlight) are denoted using a broken line 110, spectral characteristics of the light 580 (an LED light for lighting) are denoted by a dashed line 111, and spectral characteristics of light from the LED wall 505 are denoted using a solid line 112. The LED light for lighting has components in a broad wavelength region close to those of sunlight. On the other hand, light from the LED wall 505 has components only in wavelength regions of R (red), G (green), and B (blue). For this reason, for example, a component near 580 nm (near yellow) is small. In accordance with this, in a case in which the LED wall 505 is set as lighting, color reproducibility of a face and a skin of a performer 510 in the capturing video vC is degraded. More specifically, a skin color becomes reddish or the like.

Thus, in this embodiment, the camera 502 or the information processing device 70 used in the post-production ST3 is configured to be able to perform switching of a color converting process in accordance with lighting.

For example, the camera 502 or the information processing device 70 used in the post-production is configured to be able to perform a first color converting process performed using a first color setting parameter set to the light 580 in a case in which the light 580 is used as lighting and perform a second color converting process performed using a second color setting parameter set to the LED wall 505 in a case in which the LED wall 505 is used as lighting. In other words, the camera 502 or the information processing device 70 is configured to be selectively perform the first and second color converting processes.
In addition, the camera 502 or the information processing device 70 is configured to be able to perform a third color converting process performed using both the first color setting parameter and the second color setting parameter as well.

### 4. Configuration and Process Example of Camera

Hereinafter, a color converting process performed by the camera 502 will be described. First, the configuration of the camera 502 will be described with reference to FIG. 12.

The camera 502 includes a lens unit 20, an image sensor 21, a user interface unit 22 (hereinafter, referred to as “UI unit 22”), a communication unit 23, a recording control unit 24, a control unit 25, a memory unit 26, a display unit 27, and a signal processing unit 30.

The lens unit 20 is configured to include various lens such as an incident end lens, a zoom lens, a focus lens, a condensing lens, and the like and a diaphragm mechanism that performs exposure control by adjusting an opening amount according to lenses and an iris (a diaphragm) such that sensing is performed in a state in which signal electric charge is not saturated and is in a dynamic range.

The lens unit 20, for example, is configured as an interchangeable lens. Here, the lens unit may be configured as a type integrated with the main body of the camera 502.

The image sensor 21, for example, includes sensing elements of a Charge Coupled Device (CCD) type or a Complementary Metal-oxide Semiconductor (CMOS) type and a signal processing circuit for a photoelectrically-converted signal. By using the image sensor 21 having sensing elements that are two-dimensionally arranged, light from a subject incident through the lens unit 20 is photoelectrically converted. Then, for an electric signal according to the photoelectric conversion, for example, a Correlated Double Sampling (CDS) process, an Automatic Gain Control (AGC) process, and an Analog/Digital (A/D) conversion process are performed. The image sensor 21 outputs video data acquired through such processes to the signal processing unit 30.

The signal processing unit 30, for example, is configured using a microprocessor, a microcomputer, or the like that is specialized for digital signal processing such as a Digital Signal Processor (DSP).

This signal processing unit 11 performs various kinds of signal processing for video data transmitted from the image sensor 21 in accordance with a control signal SG from the control unit 25.

As the signal processing unit 30, a sensor signal processing unit 31, a white balance unit 32, a color separating unit 33, a matrix unit 34, and a development processing unit 35 are illustrated. Hereinafter, “white balance” will be denoted as “WB”. For example, the white balance unit 32 will be denoted as “WB unit 32”. In addition, in the drawing, “matrix” will be denoted as “MTX”.

The sensor signal processing unit 31 performs a black level adjusting process, a bit assignment adjusting process, a defective pixel correcting process, and the like for video data from the image sensor 21.

The WB unit 32 performs a white balance adjusting process in accordance with color setting parameters. Details thereof will be described below.

In addition, the color setting parameters described here are a value of a color temperature (in units of kelvin) and a tint value. Hereinafter, the color setting parameters will be denoted as “color temperature KL” and “tint value TT”.

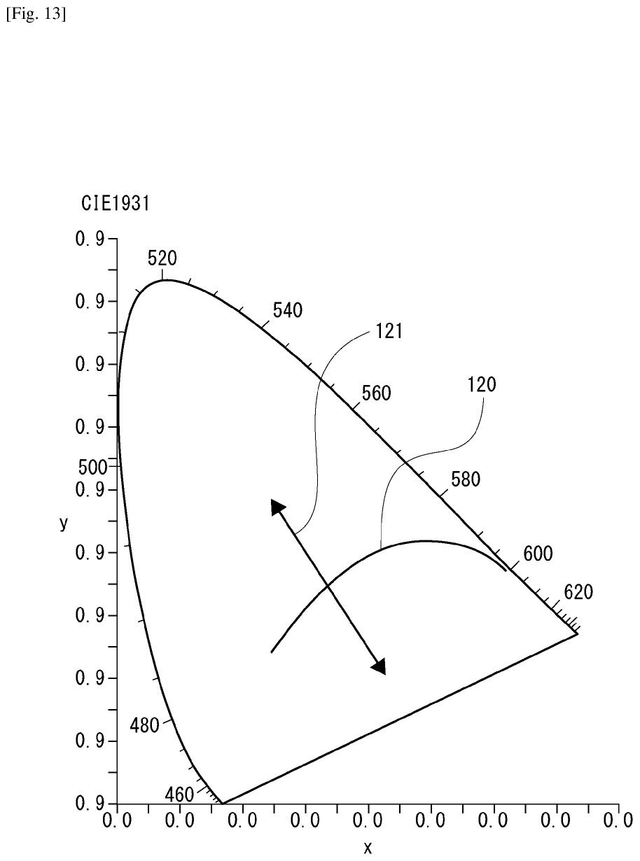

FIG. 13 illustrates a CIE1931xy chromaticity diagram, and a blackbody radiation curve 120 and an arrow 121 of a direction of a normal line thereof are illustrated. A color temperature KL is a unit representing a color of light emitted by a light source using a quantitative numerical value and is an absolute temperature represented by the blackbody radiation curve 120. The tint value TT is a parameter for adjusting a tint and a shade and is a control value for correcting the blackbody radiation curve 120 in a direction represented by the arrow 121.

In other words, in a color adjusting process, a color on the blackbody radiation curve 120 is designated by using the color temperature KL, and a deviation from the blackbody radiation curve 120 is designated using the tint value TT.

The color separating unit 33 performs a color separating process for video data after white balance adjustment. For example, in a case in which a color filter for pixels of the image sensor 21 has a Bayer arrangement, the color separating unit 33 is configured as a de-Bayer processing unit. In addition, in a case in which a mosaic color filter is used, the color separating unit 33 is configured as a de-mosaic processing unit. Furthermore, for example, also in a case in which another color filter such as a stripe color filter or the like is used, the color separating unit 33 is configured to perform color separation according to a form of the color filter.

The matrix unit 34 performs a matrix color converting process, for example, using 3×3 matrix coefficients.

This matrix unit 34 performs a process on the basis of the color temperature KL and the tint value TT as color setting parameters.

In the signal processing unit 30 illustrated in FIG. 12, the WB unit 32 and the matrix unit 34 perform color converting processes for color reproduction and color production.

The development processing unit 35 performs some or all of a gamma process, a Look Up Table (LUT) process, a resolution converting process, an encoding process for recording or communication, and the like, thereby performing conversion into video data of a final output format.

For example, video data for which the encoding process for recording has been performed is recorded on a recording medium by the recording control unit 24.

In addition, video data for which the encoding process for communication has been performed is transmitted to another device from the communication unit 23. For example, in the case of the configuration illustrated in FIG. 5 described above, video data is transmitted to the rendering engine 520.

In addition, video data for which resolution conversion for a monitor and the like have been performed is supplied to the output monitor 503 as the monitor video vM described above.

In the present disclosure, such video data acquired by the camera 502 is collectively referred to as “photographing video vC”.

In addition, for example, video data of an output stage of the sensor signal processing unit 31 may be recorded on a recording medium as raw video data vCraw by the recording control unit 24 and be transmitted from the communication unit 23.

The raw video data vCraw is video data having frames according to the pixel arrangement of the image sensor 21 in which a color filter is disposed in each pixel. Although there are somewhat different cases, this means that the raw video data is video data that can be returned to the original pixel arrangement of the image sensor 21. Thus, video data that is maintained in the pixel arrangement read from the image sensor 21 is also raw video data vCraw, and, for example, video data that has been compressed with being divided into four channels of G1 (green first pixel), G2 (green second pixel), R, and B, and the like are included in the raw video data vCraw. In addition, frames corresponding to the pixel arrangement of the image sensor 21 do not need to be in correspondence with the pixel arrangement of all the pixels of the image sensor 21. In addition, not only the pixels of R, G, and B but a white pixel may be included.

Although such raw video data vCraw is differently denoted, the raw video data is one of photographing videos vC.

In addition, in the photographing video vC (including the raw video data vCraw), metadata MT (see FIG. 30 and the like) for the video data of the photographing video vC is included as well.

The communication unit 23 performs data communication or network communication with an external device in a wired or wireless manner on the basis of a control signal SG from the control unit 25. For example, in the case of the photographing system 500, the photographing video vC (including the metadata MT) is transmitted to the rendering engine 520. The photographing video vC transmitted to the rendering engine 520 is stored, for example, in the asset server 530 for post-production.

In addition, the communication unit 23 can transmit the photographing video vC not only to the rendering engine 520 but also to various external display devices, recording devices, reproducing devices, and the like. Furthermore, the communication unit 23 may function as a network communication unit. For example, the communication unit may perform communication using various networks such as the Internet, a home network, a Local Area Network (LAN), and the like and transmit/receive various kinds of data to/from a server, a terminal, and the like on the network. For example, a photographing video vC may be considered to be transmitted as a video streaming.

The recording control unit 24 performs a process of recording the photographing video vC (including the metadata MT) on a recording medium, for example, formed from a non-volatile memory on the basis of a control signal SG from the control unit 25.

A form of the recording control unit 24 may be variously considered. For example, the recording control unit 24 may be configured to perform a recording process for a flash memory built into the camera 502 or may be configured using a memory card (for example, a flash memory of a portable type) that can be attached/detached to/from the camera 502 and an access unit performing an access for storing or reading data for this memory card. In addition, as a form being built into the camera 502, the recording control unit may be realized using an HDD, an SSD, or the like.

The display unit 27 performs a process of performing various displays for a cameraman 512. The display unit 27, for example, is a monitor on the casing of the camera 502 or an Electronic View Finder (EVF) monitor. The display unit 27 performs various displays for the photographed video vC and a user interface. For example, the display unit 27 realizes display as a Graphical User Interface (GUI) such as various operation menus, icons, messages, and the like on the screen on the basis of a control signal SG from the control unit 25.

The UI unit 22 includes a display performing image display for a user (the cameraman 512 or the like), a touch sensor, and the like and outputs operation information according to various operations such as a tap operation, a drag operation, and the like of the user for the operation image to the control unit 16.

In addition, the UI unit 22 may be formed by disposing a touch panel on the display unit 27. Furthermore, the UI unit 22 may be configured as an operation device that is separate from the camera 502.

The control unit 25 is configured using a microcomputer including a CPU and performs integral control of the camera 502.

The control unit 25, for example, performs recording control of a moving image and a still image in correspondence with an operation of the camera 502, control of a shutter speed, a gain, a diaphragm, and the like, focus control, zoom control, instructions for various signal processes in the signal processing unit 11, reproduction operation control of a recorded image file, communication control, display control, and the like.

The memory unit 26 stores information used for the process performed by the control unit 25 and the like. As the memory unit 26 that is illustrated, for example, a ROM, a RAM, a flash memory, and the like are comprehensively illustrated.

The memory unit 26 may be a memory area built into a microchip as the control unit 25 or may be configured using a separate memory chip.

In the ROM, the flash memory, and the like of the memory unit 26, a program and the like used by the control unit 25 are stored. In the ROM, the flash memory, and the like, in addition to an Operating System (OS) causing the CPU to control each unit and contents file such as an image file and the like, an application program for various operations, firmware, and the like are stored.

By executing this program, the control unit 25 controls the entire camera 502.

By temporarily storing data, a program, and the like used at the time of performing various data processes performed by the CPU of the control unit 25, the RAM of the memory unit 26 is used as a work area of the control unit 25.

The WB unit 32 and the matrix unit 34 of the camera 502 configured as described above will be described.

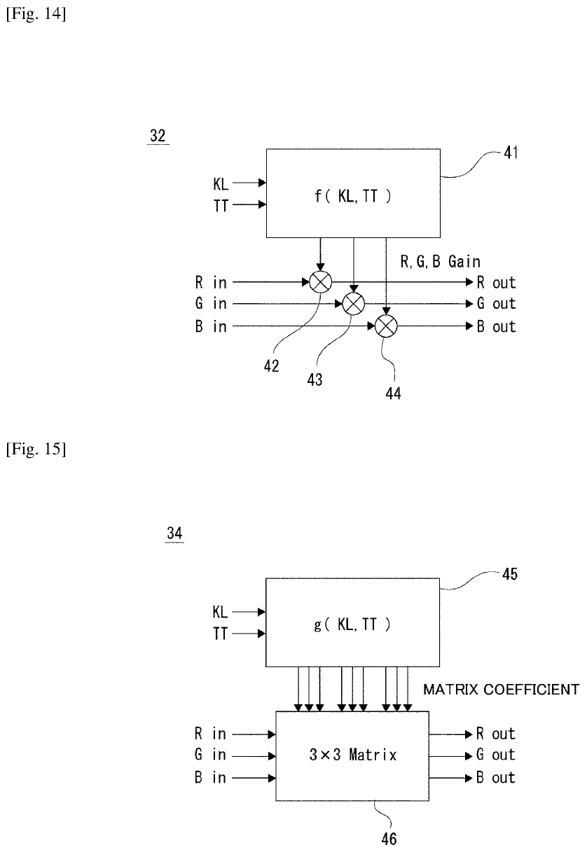

The configuration of the WB unit 32 is illustrated in FIG. 14. The WB unit 32 is configured to include a coefficient setting unit 41 and multipliers 42, 43, and 44.

For example, a color temperature KL and a tint value TT are input from the control unit 25 to the coefficient setting unit 41. The control unit 25 selects a color temperature KL and a tint value TT as color setting parameters, for example, stored in the memory unit 26 and instructs the WB unit 32 of the values thereof. Alternatively, the control unit 25 instructs the WB unit 32 of a color temperature KL and a tint value TT instructed in accordance with a user operation using the UI unit 22.

The coefficient setting unit 41 calculates an R gain, a G gain, and a B gain for white balance adjustment by performing functional operations based on a color temperature KL and a tint value TT that have been supplied.

An R value (Rin), a G value (Gin), and a B value (Bin) in video data from the sensor signal processing unit 31 are respectively input to the multipliers 42, 43, and 44. The multiplier 42 multiplies the R value (Rin) by the R gain and outputs an R value (Rout) after WB adjustment. The multiplier 43 multiplies the G value (Gin) by the G gain and outputs a G value (Gout) after WB adjustment. The multiplier 44 multiplies the B value (Bin) by the B gain and outputs a B value (Bout) after WB adjustment.

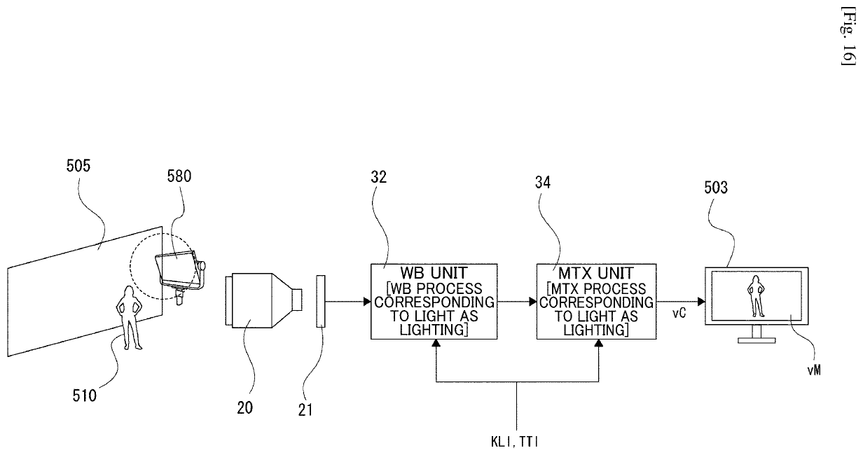

The configuration of the matrix unit 34 is illustrated in FIG. 15. The matrix unit 34 is configured to include a coefficient setting unit 45 and a matrix coefficient processing unit 46.

Similar to the WB unit 32, a color temperature KL and a tint value TT are input from the control unit 25 to the coefficient setting unit 45.

The coefficient setting unit 45 calculates 9 matrix coefficients for 3×3 operations of the R value, the G value, and the B value by performing functional operations based on a color temperature KL and a tint value TT that have been supplied.

An R value (Rin), a G value (Gin), and a B value (Bin) in video data from the color separating unit 33 are input to the matrix coefficient processing unit 46. The matrix coefficient processing unit 46 performs matrix operations using matrix coefficients for the R value (Rin), the G value (Gin), and the B value (Bin) and outputs an R value (Rout), a G value (Gout), and a B value (Bout) after color conversion.

A color converting process for color reproduction according to lighting using the camera 502 having such a configuration will be described below.

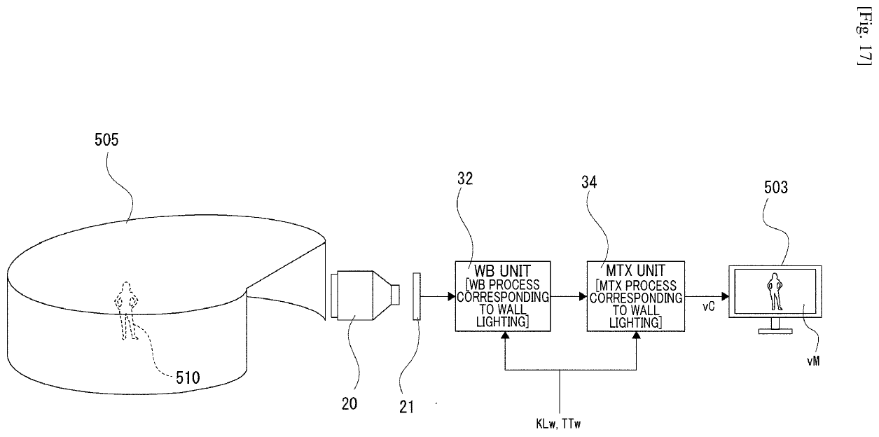

In addition, in FIGS. 16, 17, 18, 28, 30, 32, and 34 referred to in the following description, as the configuration of the camera 502, only the lens unit 20, the image sensor 21, the WB unit 32, and the matrix unit 34 are extracted and illustrated.

FIG. 16 illustrates a case in which a light 580 is used as lighting for a performer 510 in photographing using an LED wall 505 of a planar wall type illustrated in FIG. 9A.

In this case, the WB unit 32 and the matrix unit 34 are instructed with a color temperature KLl and a tint value TTl that are color reproduction coefficients optimized for illumination light of the light 580 as the color temperature KL and the tint value TT by the control unit 25.

In accordance with this, the WB unit 32 performs a white balance adjusting process corresponding to illumination light of the light 580, and the matrix unit 34 performs a matrix color converting process corresponding to the illumination light of the light 580.

In accordance with this, for example, a monitor video vM displayed on the output monitor 503 on the basis of the photographing video vC becomes a video in which the skin of the performer 510 has a natural shade as that under natural light.

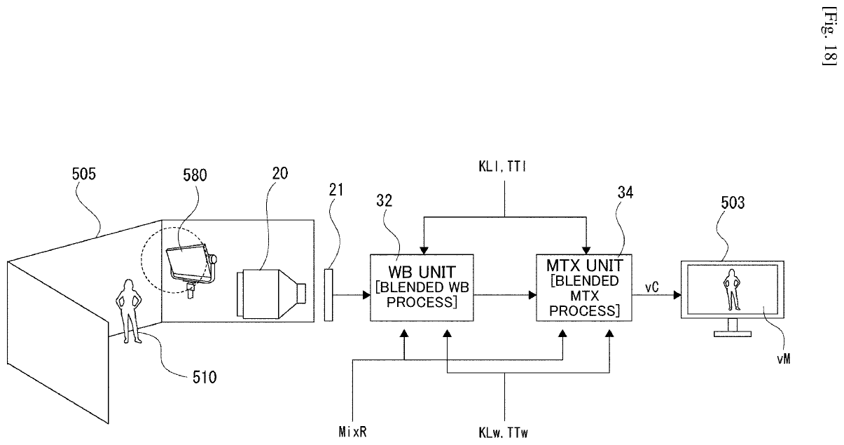

FIG. 17 illustrates a case in which an LED wall 505 is used as lighting for a performer 510 in photographing using the LED wall 505 of a cave type illustrated in FIG. 9B.

In this case, the WB unit 32 and the matrix unit 34 are instructed with a color temperature KLw and a tint value TTw that are color reproduction coefficients optimized for light of the LED wall 505 as the color temperature KL and the tint value TT by the control unit 25.
In accordance with this, the WB unit 32 performs a white balance adjusting process corresponding to the illumination light according to the LED wall 505, and the matrix unit 34 performs a matrix color converting process corresponding to the illumination light according to the LED wall 505.

In accordance with this, a monitor video vM, for example, displayed on the output monitor 503 on the basis of the photographing video vC becomes a video in which the skin of the performer 510 has a natural shade as that under natural light.

In other words, the control unit 25 changes the color temperature KL and the tint value TT as color setting parameters with which the WB unit 32 and the matrix unit 34 are instructed in accordance with a lighting form at the time of photographing. In accordance with this, either in a case in which the light 580 is used as lighting or in a case in which the LED wall 505 is used as lighting, the photographing video vC can be configured to be a video of a natural shade.

Subsequently, a case in which the light 580 and the LED wall 505 are used together for lighting will be described. For example, in the case of the curved wall type illustrated in FIGS. 10A and 10B, lightings are considered to be used together. In addition, as illustrated in FIG. 18, also in a case in which three planar-type walls are disposed on a rear face and both side faces in the LED wall 505, the light 580 and the LED wall 505 are considered to be used together as lighting.

In addition, light of the light 580 and light of the LED wall 505 being used together as lighting is not limited to the cases described above. For example, in a case in which the ceiling is disposed in the planar wall type illustrated in FIG. 9A, the cave type illustrated in FIG. 9B, the curved wall type, or the like, there are also cases in which light of the light 580 and light of the LED wall 505 are used together as lighting. FIG. 18 is merely an example illustrating a case in which light of the light 580 and light of the LED wall 505 are used together as lighting.

In a case in which light of the light 580 and light of the LED wall 505 are used together as lighting, the control unit 25 instructs the WB unit 32 and the matrix unit 34 with both pairs of a color temperature KLl and a tint value TTl that are color reproduction coefficients optimized for the illumination light of the light 580 and a color temperature KLw and a tint value TTw that are color reproduction coefficients optimized for the light of the LED wall 505.

Furthermore, the control unit 25 instructs the WB unit 32 and the matrix unit 34 with a mixing ratio MixR. The mixing ratio MixR is a ratio at which the color setting parameters for the light 580 and the color setting parameters for the LED wall 505 are reflected in the color converting process.

The control unit 25, for example, reads a mixing ratio MixR set in accordance with lighting devices used together in the memory unit 26 and can instruct the WB unit 32 and the matrix unit 34.
Alternatively, for example, by acquiring measured values of illumination light intensities of the light 580 and the LED wall 505, the control unit 25 can give an instruction with a mixing ratio MixR set in accordance with a ratio thereof.
Furthermore, the control unit 25 can give an instruction with a mixing ratio MixR set in accordance with a user' operation using the UI unit 22.

Then, the WB unit 32 performs a white balance adjusting process (a blended WB process) in which the color temperatures KLl and KLw and the tint values TTl and TTw are reflected in accordance with the mixing ratio MixR.

The matrix unit 34 performs a matrix color converting process (a blended MTX process) in which the color temperatures KLl and KLw and the tint values TTl and TTw are reflected in accordance with the mixing ratio MixR.

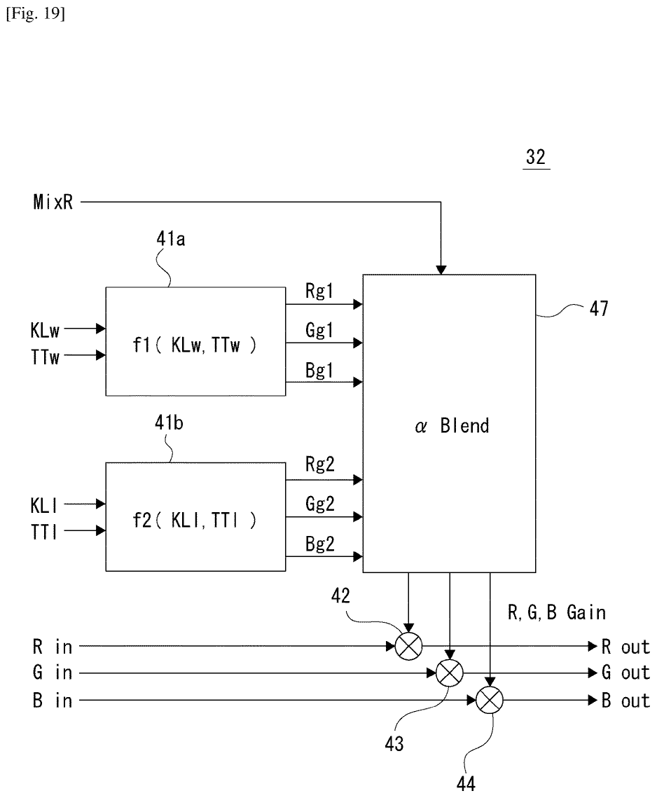

The configuration of the WB unit 32 of a case in which such processes are performed is illustrated in FIG. 19. The WB unit 32 is configured to include coefficient setting units 41a and 41b, a blended coefficient setting unit 47, and multipliers 42, 43, and 44.

The color temperature KLw and the tint value TTw are input to the coefficient setting unit 41a. The coefficient setting unit 41a calculates an R gain Rg1, a G gain Gg1, and a B gain Bg1 for white balance adjustment corresponding to illumination light of the LED wall 505 using functional operations based on the color temperature KLw and the tint value TTw.

The color temperature KLl and the tint value TTl are input to the coefficient setting unit 41b. The coefficient setting unit 41b calculates an R gain Rg2, a G gain Gg2, and a B gain Bg2 for white balance adjustment corresponding to illumination light of the light 580 using functional operations based on the color temperature KLl and the tint value TTl.

The blended coefficient setting unit 47 performs α blending of the R gain, the G gain, and the B gain at the mixing ratio MixR and sets the R gain, the G gain, and the B gain for white balance adjustment.

In other words, the blended coefficient setting unit 47 sets an R gain by blending the R gains Rg1 and Rg2 at the mixing ratio MixR. In addition, the blended coefficient setting unit 47 sets a G gain by blending the G gains Gg1 and Gg2 at the mixing ratio MixR. Furthermore, the blended coefficient setting unit 47 sets a B gain by blending the B gains Bg1 and Bg2 at the mixing ratio MixR.

The R gain, the G gain, and the B gain set in this way become coefficients of the multipliers 42, 43, and 44. Then, the R value (Rin), the G value (Gin), and the B value (Bin) in video data from each sensor signal processing unit 31 are multiplied by the R gain, the G gain, and the B gain, and an R value (Rout), a G value (Gout), and a B value (Bout) after the WB adjustment are output to the multipliers 42, 43, and 44.

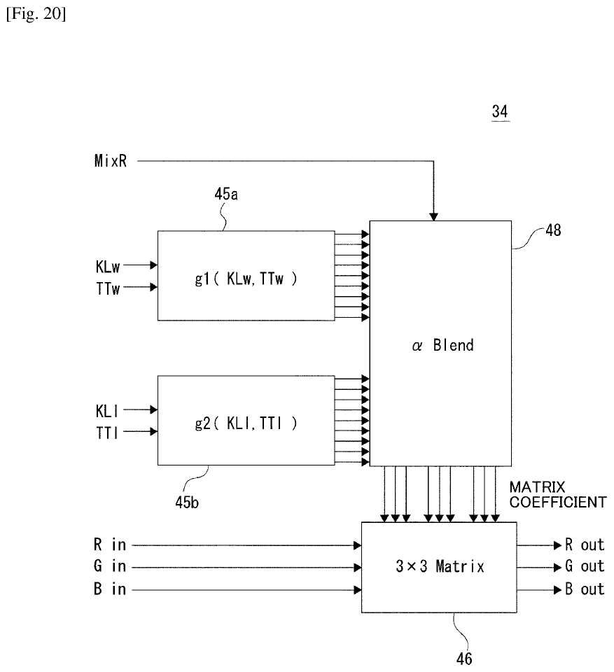

The configuration of the matrix unit 34 is illustrated in FIG. 20. The matrix unit 34 is configured to include coefficient setting units 45a and 45b, a blended coefficient setting unit 48, and a matrix coefficient processing unit 46.

The color temperature KLw and the tint value TTw are input to the coefficient setting unit 45a. The coefficient setting unit 45a calculates 9 matrix coefficients for 3×3 matrix color conversion corresponding to the illumination light of the LED wall 505 using functional operations based on the color temperature KLw and the tint value TTw.

The color temperature KLl and the tint value TTl are input to the coefficient setting unit 45b. The coefficient setting unit 45b calculates 9 matrix coefficients for 3×3 matrix color conversion corresponding to the illumination light of the light 580 using functional operations based on the color temperature KLl and the tint value TTl.

The blended coefficient setting unit 48 performs α blending of 9 coefficients from each of the coefficient setting units 45a and 45b at the mixing ratio MixR, thereby setting 9 matrix coefficients. These matrix coefficients are used by the matrix coefficient processing unit 46.

The matrix coefficient processing unit 46 performs matrix operations using matrix coefficients for the R value (Rin), the G value (Gin), and the B value (Bin) in video data from the color separating unit 33 and outputs an R value (Rout), a G value (Gout), and a B value (Bout) after color conversion.

By configuring the WB unit 32 and the matrix unit 34 as described above, a blended WB process and a blended MTX process illustrated in FIG. 18 can be performed.

By setting the mixing ratio MixR at the ratio of light intensities of illumination light of the LED wall 505 and illumination light of the light 580, an appropriate color reproduction process is performed, and a photographing video vC of a natural shade can be acquired.

In addition, the mixing ratio MixR may not be necessarily set precisely to a ratio of illumination light intensities of the LED wall 505 and the light 580. The mixing ratio may be a ratio for causing appropriate color reproduction to some degrees. In addition, by setting a mixing ratio MixR deviating from the illumination light intensity ratio, color production can be aggressively performed.

Although a case in which lights are used together has been described above, in a case in which the WB unit 32 and the matrix unit 34 are assumed to have the configurations illustrated in FIGS. 19 and 20, in the case of being in correspondence with only illumination light of the light 580 as illustrated in FIG. 16, the mixing ratio MixR between the color temperatures KLw and the color temperature KLl and between the tint value TTw and the tint value TTl may be configured to be 0:100.

In addition, in the case of being in correspondence with only the illumination light of the LED wall 505 as illustrated in FIG. 17, the mixing ratio MixR between the color temperatures KLw and the color temperature KLl and between the tint value TTw and the tint value TTl may be configured to be 100:0.

In the case of the configuration illustrated in FIG. 18, the control unit 25 may be considered to set color temperatures KLw and KLl, tint values TTw and TTl, and a mixing ratio MixR in accordance with a user operation using the UI unit 22.

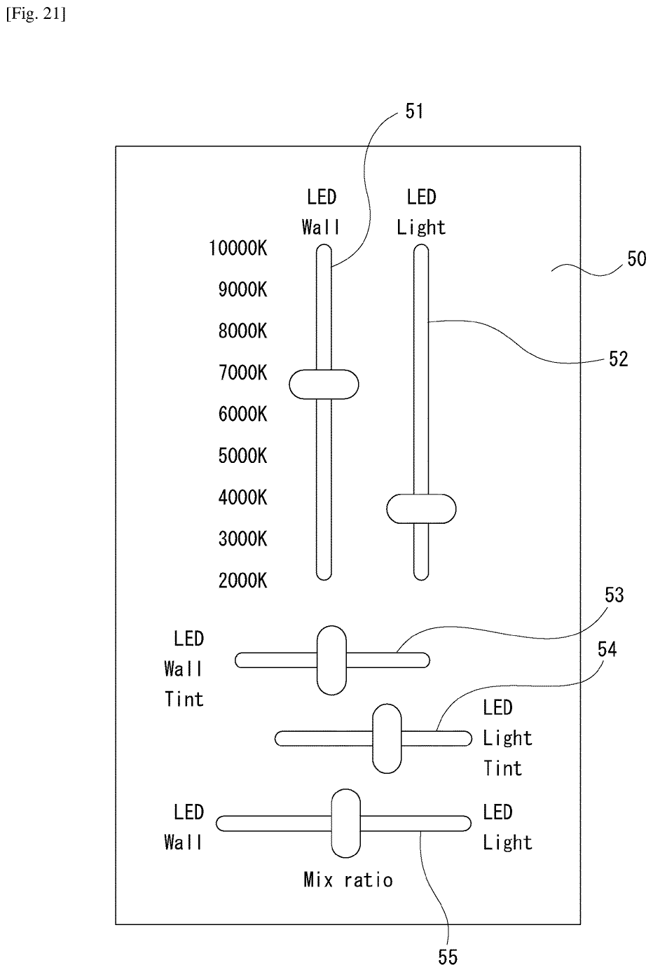

For example, the UI unit 22 performs a GUI display 50 as illustrated in FIG. 21 and enables a user's operation. In the GUI display 50, a color temperature operator 51 and a tint operator 53 corresponding to the LED wall 505, a color temperature operator 52 and a tint operator 54 corresponding to the light 580, and a mixing ratio operator 55 are prepared.

In addition, such operators may be not touch operators using display, but may be operators using actual physical levers, sliders, dials, and the like.

For example, the color temperature operator 51 and the tint operator 53 corresponding to the LED wall 505 are set to a color temperature and a tint value for optimizing color reproduction in a case in which illumination light of the LED wall 505 is used as initial values, and a user can arbitrarily change the values from the initial values.

Similarly, the color temperature operator 51 and the tint operator 53 corresponding to the light 580 are set to a color temperature and a tint value for optimizing color reproduction in a case in which illumination light of the light 580 is used as initial values, and a user can arbitrarily change the values from the initial values.

In the mixing ratio operator 55, the mixing ratio MixR can be arbitrarily set between 0:100 and 100:0.

The control unit 25 acquires operation information according to such a UI unit 22, determines the color temperatures KLw and KLl, the tint values TTw and TTl, and the mixing ratio MixR, and instructs the WB unit 32 and the matrix unit 34.

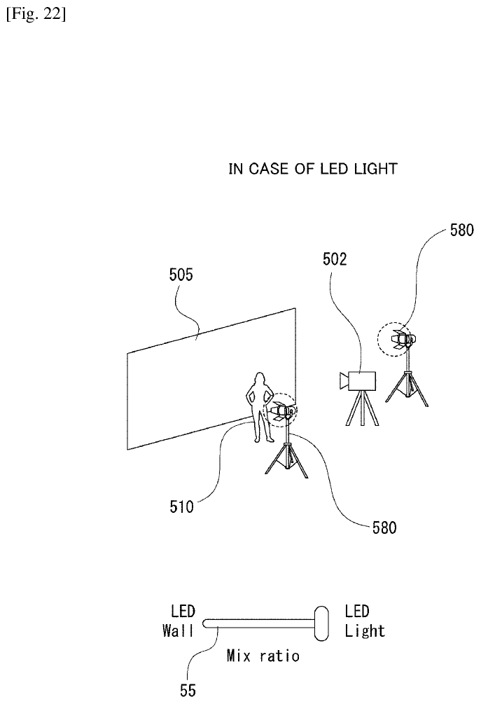

For example, in a case in which only the light 580 is used as lighting, as illustrated in FIG. 22, the user operates the mixing ratio operator 55 to a light (the LED light) side. Then, the WB unit 32 and the matrix unit 34 perform color conversion according to the color temperature KLl and the tint value TTl.

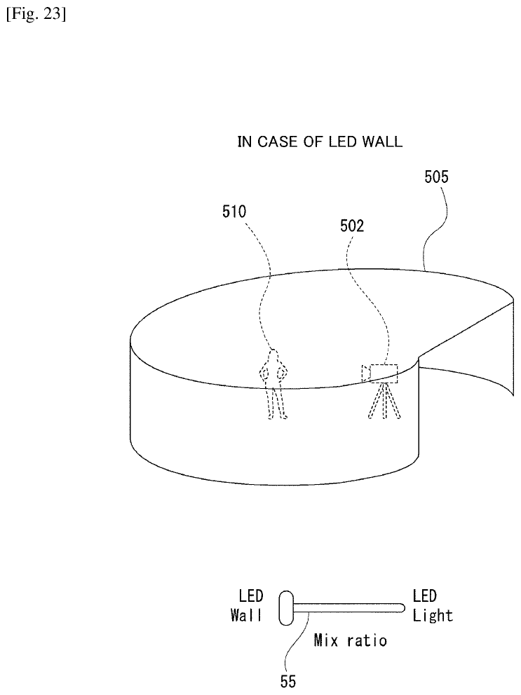

In addition, in a case in which only the LED wall 505 is used as lighting, as illustrated in FIG. 23, the user operates the mixing ratio operator 55 to an LED wall 505 side. Then, the WB unit 32 and the matrix unit 34 perform color conversion according to the color temperature KLw and the tint value TTw.

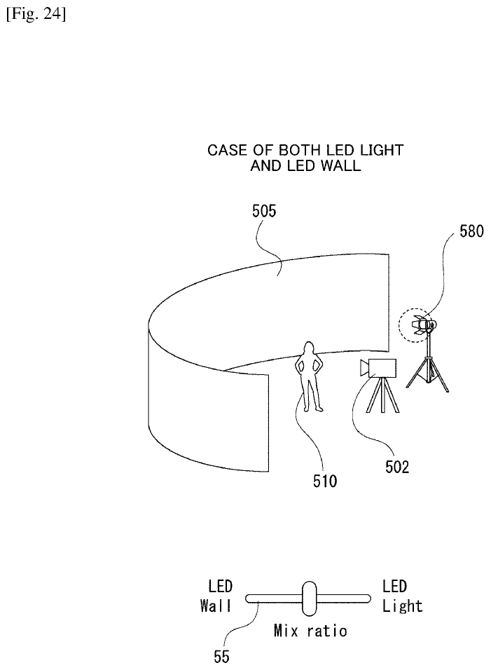

Furthermore, in a case in which the LED wall 505 and the light 580 are used together as lighting, and, for example, the illumination light intensity ratio is 50:50, as illustrated in FIG. 24, the user operates the mixing ratio operator 55 to a median value (for example, 50:50). Then, the WB unit 32 and the matrix unit 34 perform color conversion in which the color temperature KLl and the color temperature KLw and the tint value TTl and the tint value TTw are respectively reflected with 50%. It is apparent that, in a case in which the illumination light intensity ratio is different, the mixing ratio operator 55 may be operated in accordance therewith.

In accordance with the operations described above, a photographing video vC of a natural shade can be acquired.

In an actual photographing field, an illumination light intensity ratio of the LED wall 505 and the light 580 is not constantly measured. Thus, for example, it is assumed that a user operates the mixing ratio operator 55 from a state in which the mixing ratio operator 55 is set to the median value as illustrated in FIG. 24 while viewing the monitor video vM and adjusts the state to a state in which the color reproducibility is conceived to be optimal.

Furthermore, the operation of the mixing ratio operator 55 can be performed not for color reproduction of a natural shade but for aggressive color production. By operating the mixing ratio operator 55, a photographing video vC of not a natural shade but a targeted shade can be acquired in video production.

In addition, also by performing operations of the color temperature operators 51 and 52 and the tint operators 53 and 54, color production can be performed.

A process example of the camera 502 in a configuration in which the WB unit 32 and the matrix unit 34 can perform the blending process as illustrated in FIG. 18 will be described.

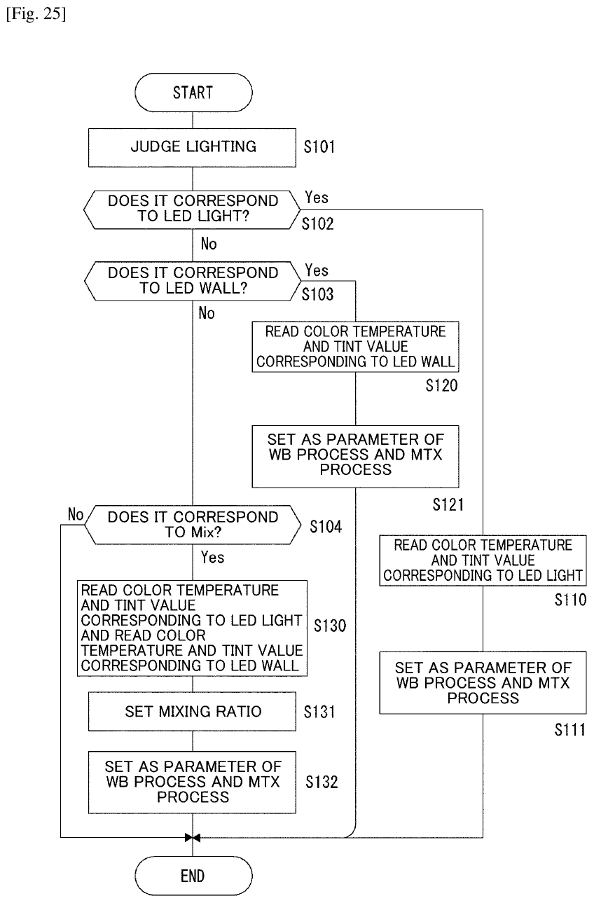

FIG. 25 illustrates a process of setting color setting parameters performed by the control unit 25 of the camera 502. For example, at a time point before start of photographing or a time point at which a lighting form is changed, the control unit 25 is considered to perform a process illustrated in FIG. 25.

In Step S101, the control unit 25 performs lighting judgment. For example, in a case in which system setting information is transferred through information transmission between devices in the photographing system 500, and the form of the LED wall 505 and the state of the light 580 can be perceived, the control unit 25 can judge the lighting form of this photographing. In addition, in a case in which an operator inputs information according to a lighting form such as a lighting mode and the like to the camera 502, the control unit 25 checks information of the lighting mode and the like.

As a result of the lighting judgment, in a case in which only the light 580 is recognized to be used as lighting in photographing of this time, the control unit 25 causes the process to proceed from Step S102 to Step S110 and reads the color temperature KLl and the tint value TTl for color reproduction corresponding to the light 580, for example, from the memory unit 26. Then, in Step S111, the control unit 25 instructs the WB unit 32 and the matrix unit 34 with the color temperature KLl and the tint value TTl as color setting parameters. In addition, as the mixing ratio MixR of this case, the color temperature KLl and the tint value TTl are set to 100%.

As a result of the lighting judgment, in a case in which only the LED wall 505 is recognized to be used as lighting in photographing of this time, the control unit 25 causes the process to proceed from Step S103 to Step S120 and reads the color temperature KLw and the tint value TTw for color reproduction corresponding to the LED wall 505, for example, from the memory unit 26. Then, in Step S121, the control unit 25 instructs the WB unit 32 and the matrix unit 34 with the color temperature KLw and the tint value TTw as color setting parameters. In addition, as the mixing ratio MixR of this case, the color temperature KLw and the tint value TTw are set to 100%.

As a result of the lighting judgment, in a case in which both the light 580 and the LED wall 505 are recognized to be used as lighting in photographing of this time, the control unit 25 causes the process to proceed from Step S104 to Step S130 and reads the color temperature KLl and the tint value TTl for color reproduction corresponding to the light 580 and the color temperature KLw and the tint value TTw for color reproduction corresponding to the LED wall 505, for example, from the memory unit 26.

In addition, in Step S131, the control unit 25 sets the mixing ratio MixR. For example, the illumination light intensity ratio of the LED wall 505 and the light 580 can be acquired, the mixing ratio MixR is set in accordance with the illumination light intensity ratio. In a case in which the illumination light intensity ratio is not clear, the mixing ratio MixR is set such that the mixing ratio MixR=50:50, a ratio set in advance, or the like.

Then, in Step S132, the control unit 25 instructs the WB unit 32 and the matrix unit 34 with the color temperature KLl, the tint value TTl, the color temperature KLw, and the tint value TTw as color setting parameters. In addition, the control unit 25 also gives an instruction relating to the mixing ratio MixR set in Step S131.

For example, in accordance with the process described above, the signal processing unit 30 of the camera 502 is set to a state in which a color converting process for appropriate color reproduction according to the lighting form at the time of photographing is performed at a time point before photographing.

In addition, in a case in which a result of the lighting judgment is not clear, the control unit 25 ends the process of FIG. 25 from Step S104.

Although the process example of the parameter setting has been described as above, as a modified example, for example, a process example in which only switching between a state for handling the light 580 illustrated in FIG. 16 and a state for handling the LED wall 505 illustrated in FIG. 17 is performed may be considered. In other words, the process example is an example in which the blending process is not performed. In such a case, the process example becomes a process example in which Steps S104, S130, S131, and S132 are not provided in FIG. 25.

In addition, although, in FIG. 25, although the control unit 25 causes the process to automatically proceed to the process of parameter settings in accordance with judgment results of Steps S102, S103, and S104, the control unit 25 may be configured to suggest a parameter setting to a user. For example, the control unit 25 displays a recommendation of color setting parameters on the display unit 27 in accordance with lighting judgment of Step S101. In accordance therewith, a user can perform a parameter setting operation using the UI unit 22.

As a process example in which a blending process is further performed, in the parameter setting process, a process example in which, while the WB unit 32 and the matrix unit 34 are constantly instructed with the color temperature KLl, the tint value TTl, the color temperature KLw, and the tint value TTw, a mixing ratio MixR is set in accordance with a result of lighting judgment, and the WB unit 32 and the matrix unit 34 are instructed therewith may be considered.

In the process of FIG. 25 and the process of the modified example thereof, although parameter settings for the WB unit 32 and the matrix unit 34 are performed, there are also cases in which the parameter settings are changed in accordance with an operation using the UI unit 22.

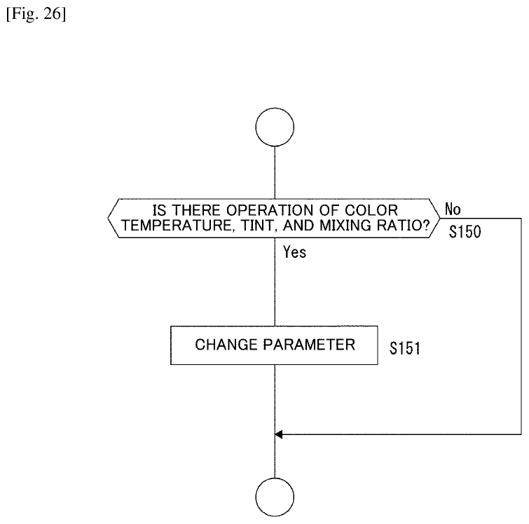

For example, the control unit 25 performs a process of FIG. 26. In step S150, the control unit 25 monitors a user operation for the GUI display 50 and checks whether or not an operation of one of the color temperature operators 51 and 52, the tint operators 53 and 54, or the mixing ratio operator 55 has been performed.

In a case in which any one thereof has been performed, the control unit 25 causes the process to proceed to Step S151 and performs parameter change. In other words, the control unit 25 changes a setting of one of the color temperature KLl, the tint value TTl, the color temperature KLw, the tint value TTw, and the mixing ratio MixR to a value set to the operator and instructs the WB unit 32 and the matrix unit 34 with the changed parameter.

In accordance with such a process, parameters of the color converting process of the signal processing unit 30 can be changed in accordance with an operator's operation at an arbitrary time. For example, at the time of a rehearsal of photographing or the like, an operator can perform adjustment of color reproductivity and color production by performing an operation on the GUI display 50 while viewing the monitor video vM.

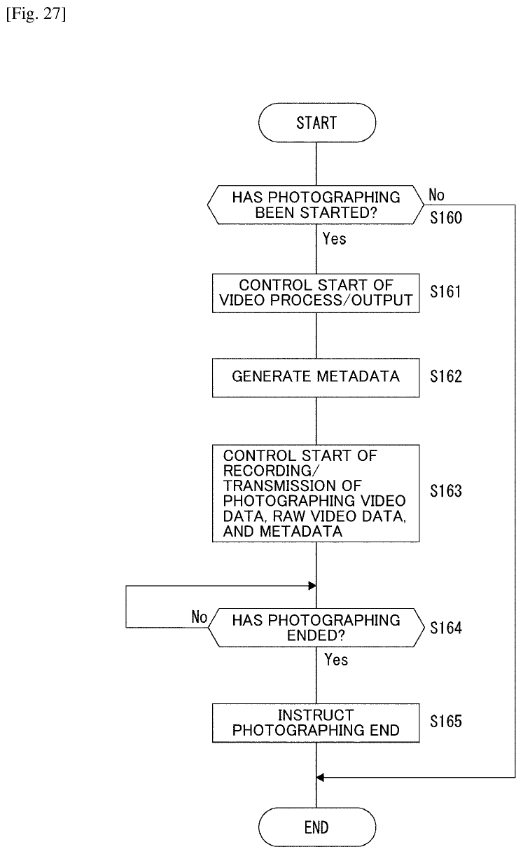

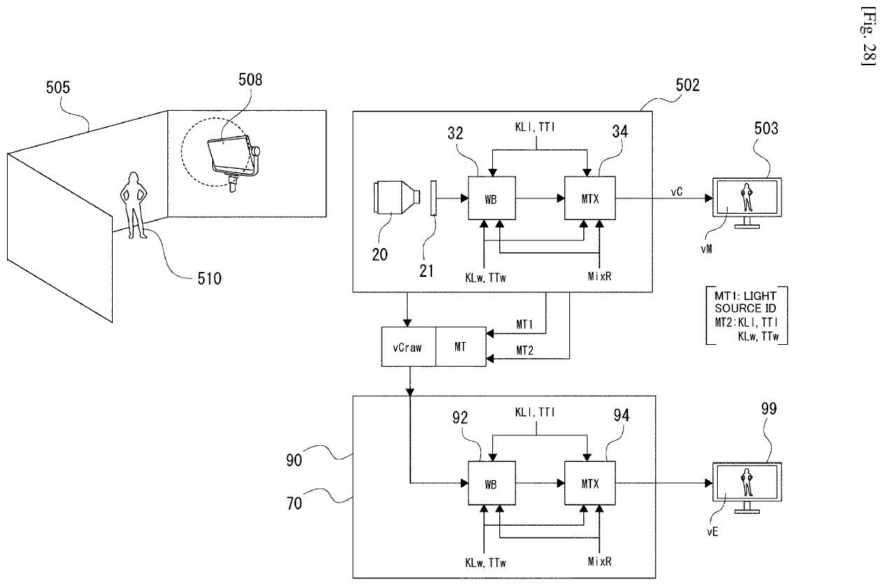

FIG. 27 illustrates a process example of the control unit 25 during photographing.

The control unit 25 causes the process to proceed to Step S161 in accordance with photographing start and gives an instruction of start of a video process using the signal processing unit 30. In accordance with this, the signal processing unit 30 starts the process described with reference to FIG. 12.

In addition, in Step S162, the control unit 25 generates metadata MT and instructs the signal processing unit 30 to associate the metadata with a frame of the photographing video vC.

Particularly, in the case of this embodiment, the control unit 25 performs a process of associating metadata relating to color setting parameters with a photographing video vC or raw video data vCraw.

Specific examples of this metadata MT include metadata MT1, MT2, MT3, MT4, and MT5 to be described below with reference to FIGS. 28, 30, and 32.

In addition, metadata MT relating to color setting parameters MT may not be necessarily associated with a frame of the photographing video vC. For example, in units of projects, more particularly, in units in which a frame rate, a recording type, and the like are set, association of the metadata MT with the photographing video vC may be considered to be performed. In addition, in units of clips of the photographing video vC or in units of files called take units of photographing, the metadata MT may be associated.

In addition, in a case in which association is performed in a file base or a case in which Serial Digital Interface (SDI) output is performed, the metadata MT may be considered to be included in baseband raw video data or a header or a footer of compressed raw video data.

In Step S163, the control unit 25 causes the signal processing unit 30 to start recording and transmission of the photographing video vC, the raw video data vCraw, and the metadata MT. In accordance with this, the signal processing unit 30 starts a process of recording the photographing video vC and the metadata MT or the raw video data vCraw and the metadata MT with being associated with each other on a recording medium and a process of transmitting and outputting the recorded data.

Thereafter, when the photographing ends, the control unit 25 causes the process to proceed from Step S164 to Step S165 and gives a photographing end instruction to the signal processing unit 30. In accordance with this, the signal processing unit 30 ends the process during photographing.

In accordance with the processes described above, the photographing video vC becomes a video for which color reproduction or color production based on the color setting parameters corresponding to the lighting form has been performed.

In addition, the raw video data vCraw with which information relating to the color setting parameters is associated as the metadata MT is recorded or transmitted.

### 5. Process Example Using Metadata and Raw Development Software

Subsequently, an example in which a process for the raw video data vCraw is performed in the post-production ST3 will be described.

In the post-production ST3, the information processing device 70 serving as a video editing device is assumed to perform a process based on raw development software 90. Here, four video processing examples performed in the information processing device 70 using the raw development software 90 will be described.

In addition, here, although a process based on the raw development software 90 will be described, hereinafter, processes described with reference to FIGS. 28 to 36 may be understood as processes performed by the information processing device 70 on the basis of raw color adjusting software.

FIG. 28 illustrates an information processing device 70 realized by the raw development software 90 used in the post-production ST3 together with a camera 502. Here, as process functions of the information processing device 70, a WB unit 92 and a matrix unit 94 are illustrated. The WB unit 92 and the matrix unit 94 are functions for performing a process of FIG. 19 and a process of FIG. 20.

FIG. 28 illustrates an example in which metadata MT1 and MT2 is associated with raw video data vCraw from the camera 502.

The metadata MT1 is a light source ID. For example, the metadata MT1 is identification information of a lighting device recognized in the process of lighting judgment of Step S101 illustrated in FIG. 25. More specifically, the light source ID is identification information of a light 580 and an LED wall 505. In addition, the light source ID may be information for identifying specific models thereof, for example, a model of the LED light, a model of LED panels 506 configuring the LED wall 505, and the like.

The metadata MT2 represents color setting parameters. In other words, the metadata MT2 is the color temperatures KLl and KLw and the tint values TTl and TTw.

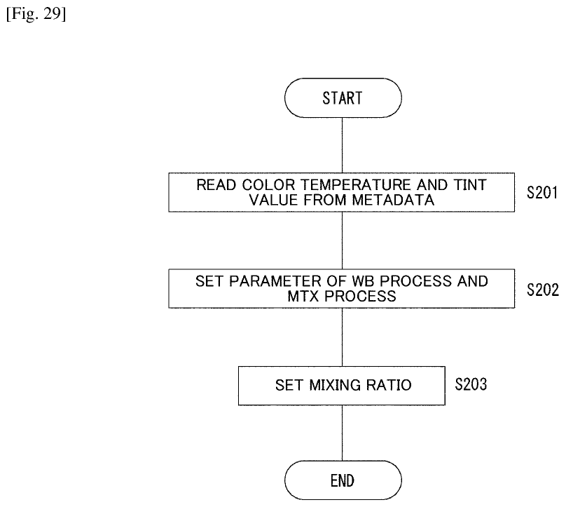

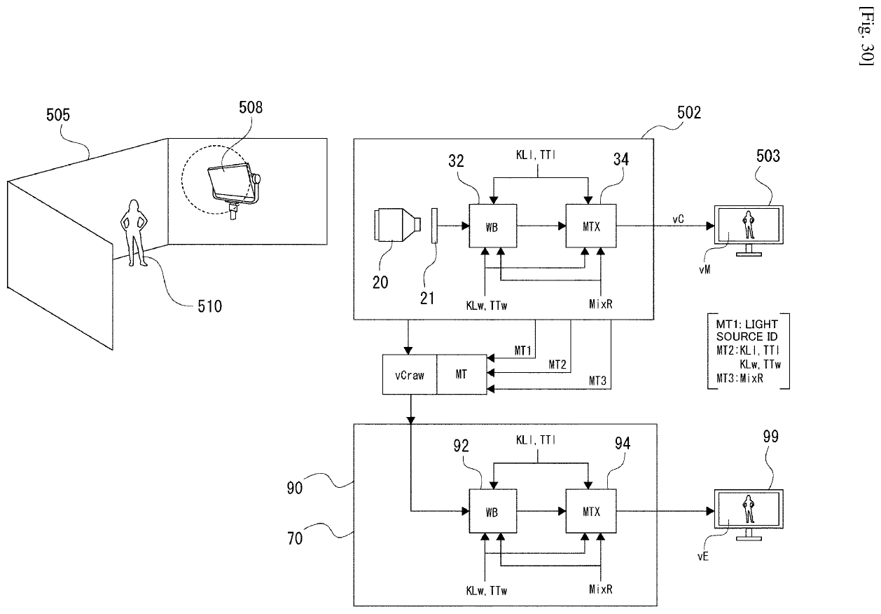

In this case, the information processing device 70 of the post-production ST3 can read the metadata MT1 and MT2 and perform a color converting process at the time of processing the raw video data vCraw. For example, the CPU 71 of the information processing device 70 performs a process of FIG. 29 on the basis of the raw development software 90.

In Step S201, the CPU 71 reads the color temperatures KLl and KLw and the tint values TTl and TTw as the metadata MT2 associated with the raw video data vCraw that is a processing target.

In Step S202, the CPU 71 sets the color temperatures KLl and KLw and the tint values TTl and TTw as color setting parameters of the WB unit 92 and the matrix unit 94.

In Step S203, the CPU 71 sets a mixing ratio MixR and instructs the WB unit 92 and the matrix unit 94 with the mixing ratio MixR. For example, on the basis of a light source ID as the metadata MT1, the CPU 71 is considered to estimate a used lighting device and an illuminance light intensity ratio in the case of using lights together and set a mixing ratio MixR.

In accordance with this, in the information processing device 70, a color converting process using the color conversion parameters at the time of photographing is performed by the WB unit 92 and the matrix unit 94, and a video vE after adjustment that is a process result thereof is displayed in the monitor device 99 used in the post-production ST3.

In addition, although the mixing ratio MixR of this case has been described to be estimated from the information of a light source ID for color reproduction, for example, the GUI as illustrated in FIG. 21 may be prepared, and a mixing ratio MixR may be set in accordance with a user's operation.

In accordance therewith, a video process in which an operator can arbitrarily set the mixing ratio MixR while using the color temperature KL and the tint value TT at the time of photographing can be performed.

In addition, while the color temperatures KLl and KLw and the tint values TTl and TTw at the time of photographing are set as initial settings, an operator can arbitrarily change values thereof.

FIG. 30 is an example in which metadata MT1, MT2, and MT3 is associated with raw video data vCraw from the camera 502.

The metadata MT3 is a mixing ratio MixR set at the time of photographing.

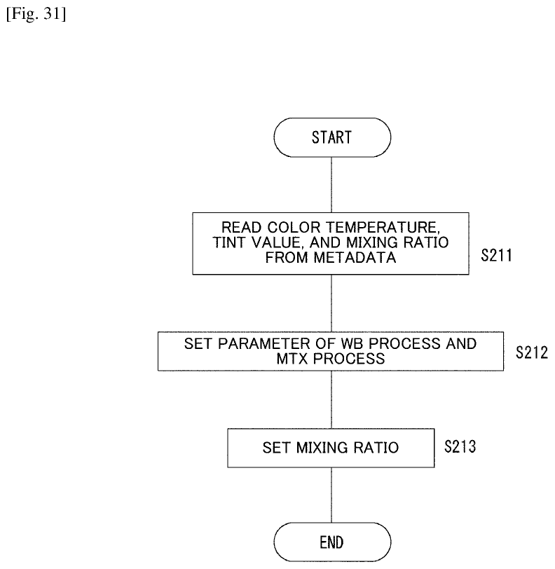

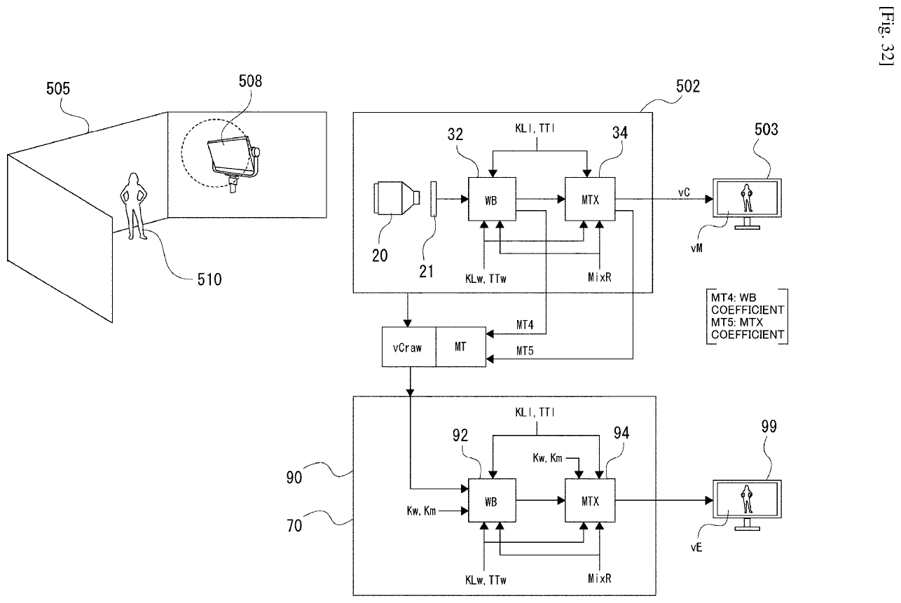

In this case, the information processing device 70 of the post-production ST3 can read the metadata MT1, MT2, and MT3 and perform a color converting process at the time of processing the raw video data vCraw. For example, the CPU 71 of the information processing device 70 performs a process of FIG. 31 on the basis of the raw development software 90.

In Step S211, the CPU 71 reads the color temperatures KLl and KLw and the tint values TTl and TTw as metadata MT2 associated with the raw video data vCraw that is a processing target and reads the mixing ratio MixR as metadata MT3.

In Step S212, the CPU 71 sets the color temperatures KLl and KLw and the tint values TTl and TTw as parameters of the WB unit 92 and the matrix unit 94.

In Step S213, the CPU 71 instructs the WB unit 92 and the matrix unit 94 with the mixing ratio MixR as the metadata MT3.

In accordance with this, in the information processing device 70, a color converting process similar to that at the time of photographing is performed by the WB unit 92 and the matrix unit 94, and a video vE after adjustment that is a process result thereof is displayed in the monitor device 99.

In addition, in this example, the metadata MT1 as a light source ID is not necessarily needed. However, by including the metadata MT, adjustment and the like of color temperatures and tint values according to a light source type of a used lighting device or a mixing ratio can be performed.

In addition, also in this case, for example, the GUI as illustrated in FIG. 21 may be prepared, and the mixing ratio MixR, the color temperatures KLl and KLw, and the tint values TTl and TTw may be set in accordance with a user's operation.

In accordance with this, a video process in which, while parameter settings similar to those at the time of photographing are set as initial values, and an operator arbitrary sets the parameters can be performed.

FIG. 32 is an example in which metadata MT4 and MT5 is associated with raw video data vCraw from the camera 502.

The metadata MT4 is a value of a white balance coefficient (an R gain, a G gain, and a B gain) of the WB unit 32 at the time of photographing. In description, the metadata MT4 will be denoted as a white balance coefficient Kw.

The metadata MT5 is 9 matrix coefficients for 3×3 matrix color conversion used by the matrix unit 34 at the time of photographing. In description, the metadata MT5 will be denoted as a matrix coefficient Km.

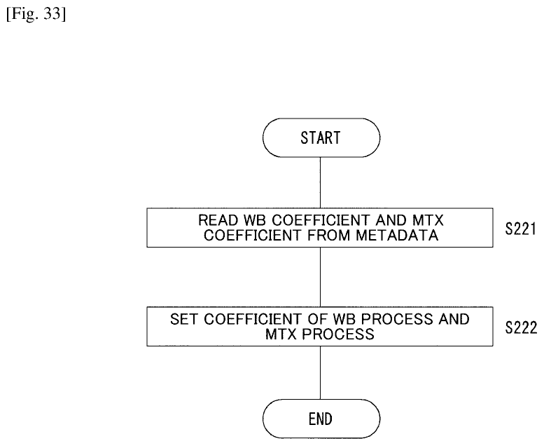

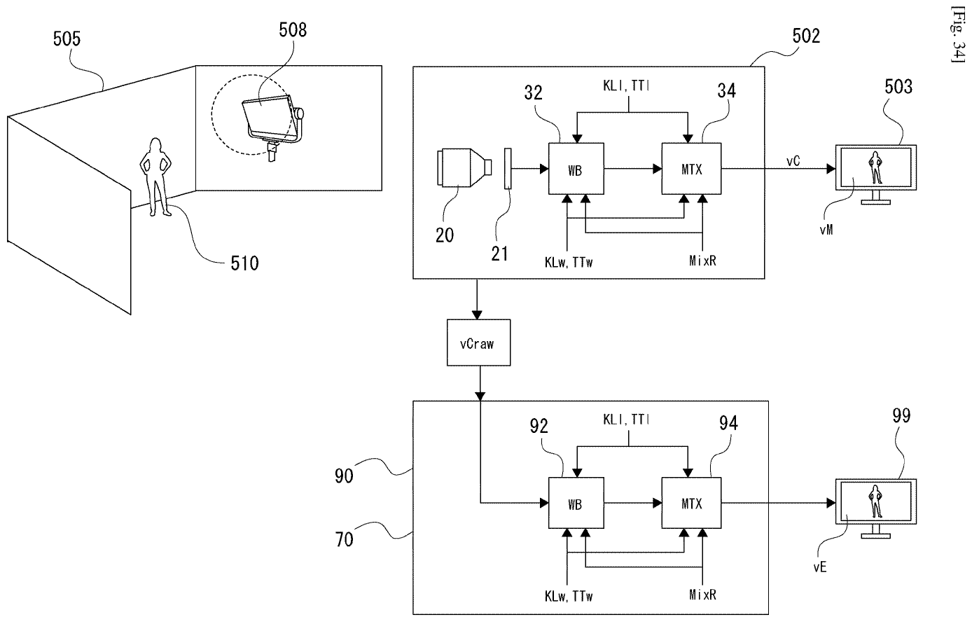

In this case, the information processing device 70 of the post-production ST3 can read the metadata MT4 and MT5 and perform a color converting process at the time of processing the raw video data vCraw. For example, the CPU 71 of the information processing device 70 performs a process of FIG. 33 on the basis of the raw development software 90.

In Step S221, the CPU 71 reads a white balance coefficient Kw and a matrix coefficient Km as the metadata MT4 and MT5 associated with the raw video data vCraw that is a processing target.

In Step S222, the CPU 71 instructs the WB unit 92 and the matrix unit 94 with the white balance coefficient Kw and the matrix coefficient Km that have been read.

The white balance coefficient Kw and the matrix coefficient Km are coefficient values after reflection of the mixing ratio MixR at the time of photographing.

Thus, even when an instruction regarding the color temperatures KLl and KLw, the tint values TTl and TTw, and the mixing ratio MixR is not given, a color converting process similar to that at the time of photographing is performed by the WB unit 92 and the matrix unit 94, and a video vE after adjustment that is the process result thereof is displayed in the monitor device 99.

However, also in this case, for example, the GUI as illustrated in FIG. 21 may be prepared, and the mixing ratio MixR, the color temperatures KLl and KLw, and the tint values TTl and TTw may be set in accordance with a user's operation.

In accordance with this, a video process in which an operator can arbitrarily set parameters from a state in which color conversion similar to that at the time of photographing is performed, and color production is performed can be performed.

FIG. 34 is an example in which metadata relating to a color converting process is not associated with raw video data vCraw from the camera 502.

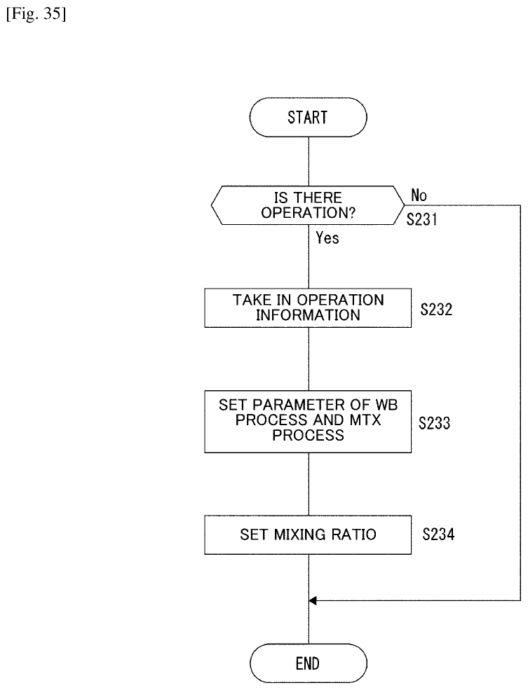

In this case, the information processing device 70 of the post-production ST3, for example, prepares the GUI as illustrated in FIG. 21 and, for example, performs a process of FIG. 35 at the time of processing the raw video data vCraw.

In Step S231, the CPU 71 monitors a user's operation relating to the color converting process. In a case in which there is an operation, the CPU 71 takes in operation information in Step S232.

In Step S233, the CPU 71 sets the color temperatures KLl and KLw and the tint values TTl and TTw in accordance with the operation and instructs the WB unit 92 and the matrix unit 94.

In addition, in Step S234, the CPU 71 sets the mixing ratio MixR in accordance with the operation and instructs the WB unit 92 and the matrix unit 94.

In accordance with the description presented above, a video process in which an operator performs color production for the raw video data vCraw regardless of color conversion at the time of photographing can be performed.

In the processes of FIGS. 29, 31, and 33, an example in which color setting parameters (color temperatures and tint values) are set in accordance with the metadata MT, or process coefficients (the white balance coefficient Kw and the matrix coefficient Km) are set has been illustrated. Then, in such a case, after such settings, furthermore, an operator has been described to be able to correct colors by performing an operation using the GUI as illustrated in FIG. 21.

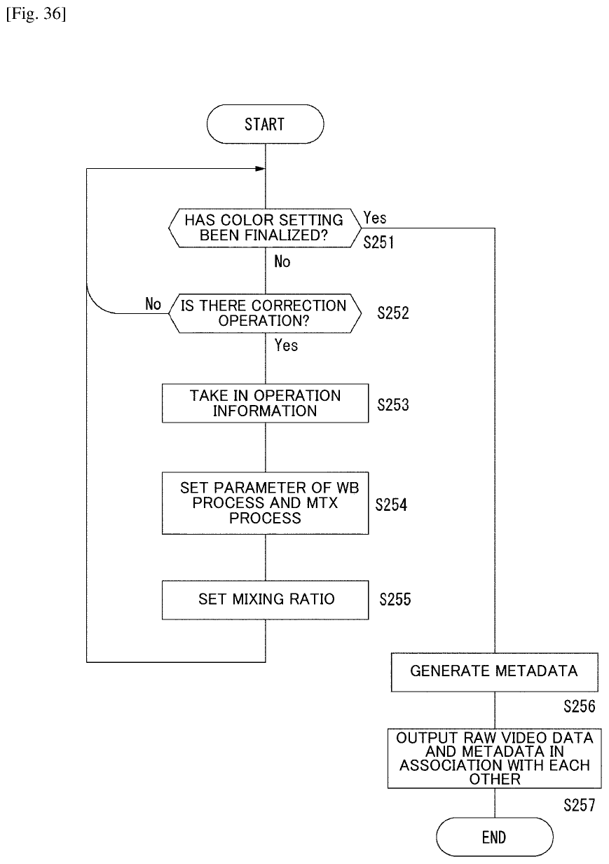

Thus, the information processing device 70 may be configured to perform the process of FIG. 36 together with the process of FIG. 29, 31, or 33 on the basis of the raw development software.

The process of FIG. 36 will be described. The CPU 71 of the information processing device 70, for example, after setting the color setting parameters or the process coefficients in the process of FIG. 29, 31, or 33, checks whether or not color setting for the raw video data vCraw has been finalized in Step S251. In other words, it is checked whether or not an operator has performed an operation of completing the color process.

Until a completion operation is detected, the CPU 71 monitors an operator's correction operation in Step S252. The operator can arbitrarily operate the color temperatures and the tint values for the LED wall 505, the color temperatures and the tint values for the light 580, and the mixing ratio MixR using the GUI illustrated in FIG. 21. The CPU 71 causes the process to return to Step S251 when there is none of such operations and causes the process to proceed to Step S253 and takes in operation information in a case in which there is any one of the operations.

In a case in which the operation information is taken in, the CPU 71, in Step S254, sets the color temperatures KLl and KLw and the tint values TTl and TTw in accordance with the operation and instructs the WB unit 92 and the matrix unit 94.

In addition, in Step S255, the CPU 71 sets the mixing ratio MixR in accordance with the operation and instructs the WB unit 92 and the matrix unit 94. Then, the process returns to Step S251.

In accordance with the processes described above, until color setting is finalized, an operator's color correction is arbitrarily performed.

In a case in which the operator performs an operation of finalizing the color setting, for example, an operation of instructing output (recording, transmission, upload, or the like) of the raw video data vCraw at the time point, the CPU 71 causes the process to proceed from Step S251 to Step S256 and generates metadata MT. In this case, the metadata MT includes all or some of the color temperatures KLl and KLw, values of the tint values TTl and TTw, the mixing ratio MixR, the white balance coefficient Kw, the matrix coefficient Km, and the like at the time point.

Then, in Step S257, the CPU 71 outputs the raw video data vCraw and the metadata MT in association with each other.

For example, the CPU 71 controls recording on a recording medium or transmission, upload, or the like for another device in a state in which the raw video data vCraw and the metadata MT are associated with each other. In addition, in this case, in addition to the raw video data vCraw and the metadata MT, all the video data of which the color setting has been processed by the WB unit 92 and the matrix unit 94 or all the video data of which development has been processed may be output.

In accordance with the processes described above, metadata MT including the color setting parameters after correction and the process coefficients is set as output contents together with the raw video data vCraw. Thus, in stages of the video processing after that, processes performed by the information processing device 70 can be reproduced.

Although the process of FIG. 36 has been described to be performed after the process of FIG. 29, 31, or 33, for example, in the case of the example described in FIG. 34, the process described above may be performed in place of the process of FIG. 35.

In addition, although the process of FIG. 36 has been described to be performed by the information processing device 70 on the basis of the raw development software 90 (or the raw color adjusting software), it may be the process performed by the control unit 25 of the camera 502. In other words, it is an example in which the camera 502 outputs metadata MT including the raw video data vCraw and color setting parameters and process coefficients after operator's color correction operation.

### 6. Summing-Up and Modified Example

According to the embodiments described above, the following effects can be acquired.

The camera 502 that is the photographing device according to the embodiment includes the image sensor 21 and the signal processing unit 30. The signal processing unit 30 can perform the first color converting process performed using the first color setting parameters (the color temperature KLl and the tint value TTl) set for the first lighting (the light 580) for video data acquired by the image sensor 21. In addition, the signal processing unit 30 can perform the second color converting process performed using the second color setting parameters (the color temperature KLw and the tint value TTw) set for the second lighting (the LED wall 505) that has spectral characteristics different from the first lighting and uses the display device displaying a background video. The signal processing unit 30 is configured to be able to selective perform these first and second color converting processes.

In a photographing environment of a case in which the LED wall 505 (the second lighting) is used, there are a case in which the light 580 (the first lighting such as an LED light or the like) is used and a case in which the LED wall 505 is used as lighting). Light from the LED wall 505 does not have spectral characteristics optimized for the use of lighting. Also in such a case, by performing the second color converting process using the color setting parameters set for the spectral characteristics of the LED wall 505, the color reproduction of the photographing video vC can be improved.

In addition, in the embodiment, although the background video vB that is a video displayed on the LED wall 505 is a virtual video acquired through rendering using a 3D model, for example, the technology of the present disclosure can be applied also to a case in which a photographed video is displayed on the LED wall 505.

In the embodiment, an example in which the signal processing unit 30 is configured to be able to perform the third color converting process that is performed using both the first color setting parameters and the second color setting parameters has been described.

For example, in a case in which both the LED wall 505 and the light 580 are used, by performing the color converting process in which the parameters KLw and TTw used for the LED wall 505 and the parameters KLl and TTl used for the light 580 are reflected, the color reproduction of the photographing video vC can be improved.

In addition, also in a case in which the WB unit 32 and the matrix unit 34 have the configurations illustrated in FIGS. 19 and 20, in a case in which the mixing ratio MixR of the color temperature KL and the tint value TT is 0:100 or 100:0, the process of the WB unit 32 and the matrix unit 34 corresponds to the first or second color converting process.

In a case in which the mix ratio MixR is neither 0:100 nor 100:0, in other words, a color converting process in which all the color temperatures KLw and KLl and the tint values TTw and TTl are reflected becomes the third color converting process described in the present disclosure.

In the embodiment, an example in which the signal processing unit 30 sets a degree of reflection of the first color setting parameters and the second color setting parameters on the third color converting process in accordance with the mixing ratio MixR has been described.

In a case in which both the LED wall 505 and the light 580 are used, there are various degrees of contribution thereof as illumination light. Thus, a ratio of reflection of the color setting the parameters KLw and TTw used for the LED wall 505 and the color setting parameters KLl and TTl used for the light 580 is set in accordance with the mixing ratio MixR. In accordance with this, a color converting process according to a ratio of intensities as illumination lights of the LED wall 505 and the light 580 can be performed.

In the embodiment, an example in which the signal processing unit 30 of the camera 502 performs the process of associating the first color setting parameters and the second color setting parameters with video data as metadata MT is performed has been described. In addition, an example in which the information processing device 70 used in the post-production ST3 reads the first color setting parameters and the second color setting parameters from metadata associated with video data and applies them to the color converting process has been described.

For example, as in the examples illustrated in FIGS. 28 and 30, the color setting parameters KLw and TTw used for the LED wall 505 and the color setting parameters KLl and TTl used for the light 580 are associated with the raw video data vCraw as the metadata MT2.

In accordance with this, when the process for the raw video data vCraw is performed by the information processing device 70 in which the raw development software 90 has been installed, a color reproducing process using all or some of the color setting parameters KLw, TTw, KLl, and TTl at the time of photographing can be performed.

In addition, only the color setting parameters KLl and TTl used for the light 580 that are the first color setting parameters may be associated with the raw video data vCraw as the metadata MT2. To the contrary, only the color setting parameters KLw and TTw used for the LED wall 505 that are the second color setting parameters may be associated with the raw video data vCraw as the metadata MT2. In other words, a process of associating at least one side of the first color setting parameters and the second color setting parameters with the video data is performed.

In addition, the process of association with the photographing video data is a process in which, for example, the color setting parameters KLw, TTw, KLl, TTl, and the like are set as metadata MT, are set as data included in a video file together with raw video data vCraw, and are recorded on a recording medium or transmitted to an external device. Alternatively, even when such metadata MT is data of a file different from the file of the raw video data vCraw, by performing a process of maintaining the data to be in a managed state by associating the data with each other through assignment of the same ID or the like, the data may be associated with each other.

In the embodiment, an example in which the signal processing unit 30 of the camera 502 performs the process of associating the mixing ratio MixR of the first color setting parameters and the second color setting parameters in the third color reproducing process with video data has been described. In addition, an example in which the information processing device 70 used in the post-production ST3 reads the mixing ratio MixR from metadata associated with the video data and applies the mixing ratio to the color converting process has been described.

For example, as in the example illustrated in FIG. 30, the mixing ratio MixR is associated with the raw video data vCraw as the metadata MT3.

In accordance with this, when the process for the raw video data vCraw is performed thereafter, a color reproducing process using the mixing ratio MixR at the time of photographing can be performed. Particularly, by associating the mixing ratio MixR together with the color setting parameters KLw, TTw, KLl, and TTl, when the process for the raw video data vCraw is performed by the information processing device 70 in which the raw development software 90 functions, a color reproducing process of a mixing ratio that is similar to that at the time of photographing can be performed.

In the embodiment, an example in which the signal processing unit 30 of the camera 502 performs the process of associating the process coefficients of the color converting process according to the first color setting parameters and the second color setting parameters with video data has been described. In addition, an example, in which the information processing device 70 used in the post-production ST3 reads process coefficients (the white balance coefficient Kw and the matrix coefficient Km) of the color converting process according to the first color setting parameters and the second color setting parameters from the metadata associated with video data and applies them to the color converting process has been described.

For example, as in the example of FIG. 32, the white balance coefficient Kw and the matrix coefficient Km set on the basis of the color setting parameters KLw, TTw, KLl, and TTl at the time of photographing are associated with the raw video data vCraw as metadata MT4 and MT5 and can be used in the post-production ST3.

In accordance with this, when the process for the raw video data vCraw is performed by the information processing device 70 in which the raw development software 90 functions, a color reproducing process similar to that at the time of photographing can be performed.

In the embodiment, the signal processing unit 30 of the camera 502 and the information processing device 70 used in the post-production ST3 perform the white balance adjusting process as one of color converting processes.

In accordance with the white balance adjustment, a natural shade can be acquired by absorbing a difference between color temperatures of light sources of lighting.

In the embodiment, the signal processing unit 30 of the camera 502 and the information processing device 70 used in the post-production ST3 perform a matrix color converting process as one of color converting processes.

In accordance with the matrix color converting process, a natural shade can be acquired by absorbing a difference between spectral characteristics of light sources of lighting.

In addition, a process equivalent to the matrix color converting process may be performed as a 3D LUT converting process using a three-dimensional lookup table (3D LUT).

In the embodiment, an example in which the UI unit 22 that can give an instruction of the first and second color setting parameters is included, and the signal processing unit 30 is configured to be able to perform the first color converting process or the second color converting process using the first and second color setting parameters instructed by the UI unit 22 has been described.

A user can designate the first color setting parameters (the color temperature KLl and the tint value TTl) or the second color setting parameters (the color temperature KLw and the tint value TTw) using the UI unit 22. In accordance with this, the user can perform the color converting process for color reproduction in accordance with lighting. In addition, the user can instruct not only simple color reproduction but a color converting process of for so-called desired color production.

In the example of FIG. 21, although the UI is configured to be able to designate the mixing ratio MixR as well, a UI configured not to be able to designate the mixing ratio MixR may be considered as well.

In the embodiment, an example in which the UI unit 22 that is configured to be able to instruct the first and second color setting parameters and ratio information is included, and the signal processing unit 30 is configured to be able to perform the third color converting process using the first and second color setting parameters and the ratio information instructed by the UI unit 22 has been described.

The user can designate the mixing ratio MixR together with the color setting parameters KLl, TTl, KLw, and TTw using the UI unit 22. In accordance with this, the user can perform a color converting process for color reproduction and color production even in a situation in which both the light 580 and the LED wall 505 are used as lighting.

In addition, a UI in which the color setting parameters KLl, TTl, KLw, and TTw, for example, are preset to fixed values, and only the mixing ratio MixR can be arbitrarily designated by the user may be considered.

In the embodiment, the first and second color setting parameters include color temperatures and tint values.

For example, by setting the process coefficients as white balance adjustment and the matrix color converting process on the basis of the color temperatures and the tint values, appropriate color reproduction according to lighting is realized.

In the embodiment, the camera 502 outputs the raw video data vCraw. In addition, for example, by the control unit 25 of the camera 502 performing the process as illustrated in FIG. 36, the signal processing unit 30 corrects at least one side of the first color setting parameters and the second color setting parameters, and corrected first color setting parameters or the corrected second color setting parameters or the process coefficients of the WB unit 32 and the matrix unit 34 can be associated with the raw video data vCraw.

In accordance with this, the color setting parameters and the process coefficients in which the operator's correction has been reflected can be set as output contents together with the raw video data vCraw. Thus, in a subsequent process, color settings corrected by the camera 502 can be reproduced.

In the embodiment, an example in which the control unit 25 of the camera 502 performs a process of automatically performing one of the first color converting process and the second color converting process or suggesting one of the first color converting process and the second color converting process to a user on the basis of the shape of the display device or correspondence/non-correspondence of the LED light has been described. In other words, in the process of FIG. 25, parameter settings are performed in accordance with lighting judgment of Step S101. Alternatively, as described in the modified example thereof, a recommendation of color setting parameters is given to a user. In accordance with this, in a case in which a color process having good reproducibility is required, a user's burden can be alleviated.

A program according to an embodiment is a program, for example, causing a processor such as a CPU, a DSP, or the like or a device including these to execute the processes as illustrated in FIGS. 29, 31, 33, 35, and 36 described above. In other words, the program according to the embodiment is a program causing the information processing device 70 to perform the first color converting process performed using the first color setting parameters set for the first lighting and the second color converting process performed using the second color setting parameters set for the second lighting having spectral characteristics different from the first lighting and using a display device displaying a background video vB, with respect to the video data (for example, the RAW video data vCraw) obtained by the camera 502.

In accordance with such a program, for example, by using the information processing device 70 functioning as a video editing device in the post-production ST3, a color converting process for color reproduction relating to the photographing video vC can be performed. Particularly, in correspondence with a case in which the light 580 is used as lighting and a case in which the LED wall 505 is used as lighting, color reproduction of the photographing video vC can be improved.

In addition, the program according to the embodiment is also a program that causes the information processing device 70 to perform the third color converting process performed using both pairs of the first color setting parameters and the second color setting parameters.

For example, in correspondence with a case in which both the LED wall 505 and the light 580 are used, the color converting process in which the parameters KLw and TTw used for the LED wall 505 and the parameters KLl and TTl used for the light 580 are reflected is performed using the information processing device 70 at the time of the post-production ST3 or the like, whereby color reproduction of the photographing video vC can be improved.

The program according to the embodiment is software causing the information processing device 70 to perform a development process for the raw video data vCraw as photographing video data according to the camera 502. In other words, the program is a program as so-called raw development software 90. In accordance with this, a program that is appropriate when the raw video data vCraw is processed in the post-production ST3 is realized.

In addition, the photographing video vC processed in the post-production ST3 is not limited to the raw video data vCraw described above. For example, a process similar thereto can be performed for the photographing video vC after the development process.

In addition, for example, video data after the process of the WB unit 32 of the camera 502 may be output as raw video data vCraw, and a process similar thereto may be considered to be performed for such raw video data vCraw.

In the program according to the embodiment, an example in which the information processing device 70 performs a process of correcting at least one side of the first color setting parameters and the second color setting parameters and associating the corrected first color setting parameters or the corrected second color setting parameters with the raw video data vCraw has been described (see FIG. 36).

In accordance with this, the color setting parameters and the process coefficients in which the operator's correction has been reflected can be configured as output contents together with the raw video data vCraw. In accordance with this, a color setting corrected by the information processing device 70 on the basis of the raw development software 90 can be reproduced in subsequent processes.

An example in which the program according to the embodiment causes the information processing device 70 to apply the first color setting parameters and the second color setting parameters that are metadata associated with video data according to the camera 502 to the color converting process has been described. In accordance with this, the process of the post-production ST3 described with reference to FIGS. 28 and 29 is performed.

In addition, one side of the first color setting parameters and the second color setting parameters may be applied to a color converting process.

In addition, an example in which the program according to the embodiment causes the information processing device 70 to apply ratio information of the first color setting parameters and the second color setting parameters, which is metadata associated with video data according to the camera 502, to a color converting process has been described. In accordance with this, the process of the post-production ST3 described with reference to FIGS. 30 and 31 is performed.

In addition, an example in which the program according to the embodiment causes the information processing device 70 to apply the process coefficients (the white balance coefficient Kw and the matrix coefficient Km) of the color converting process corresponding to the first and second color setting parameters, which are metadata associated with video data according to the camera 502, to the color converting process has been described. In accordance with this, the process of the post-production ST3 described with reference to FIGS. 32 and 33 is performed.

In addition, one side of the process coefficients according to the first color setting parameters and the process coefficient according to the second color setting parameters may be applied to the color converting process.

Furthermore, an example in which the program according to the embodiment causes the information processing device 70 to perform a color converting process according to the first and second color setting parameters designated in accordance with a user's operation has been described.

For example, for the raw video data vCraw, regardless of presence/absence of metadata such as parameters and the like relating to a color converting process, the UI as illustrated in FIG. 21 is provided also in the information processing device 70, and thus, as described with reference to FIGS. 34 and 35, the color converting process for reproduction or color production can be performed in accordance with a user's operation.

The program according to the embodiment described above can be recorded in advance in an HDD as a recording medium built into a device such as a computer device or the like, a ROM inside a microcomputer having a CPU, or the like. In addition, such a program may be temporarily or perpetually stored (recorded) in a removable recording medium such as a flexible disc, a Compact Disc Read Only Memory (CD-ROM), a Magneto Optical (MO) disc, a Digital Versatile Disc (DVD), a Blu-ray Disc (registered trademark), a magnetic disk, a semiconductor memory, a memory card, or the like. Such a removable recording medium can be provided as so-called package software.

In addition, such a program may be installed from a removable recording medium to a personal computer or the like or may be downloaded from a download site through a network such as a Local Area Network (LAN), the Internet, or the like.

In addition, such a program is appropriate for broadly providing the information processing device 70 according to the embodiment. For example, by downloading a program into a personal computer, a communication device, a portable terminal device such as a smartphone, a tablet, or the like, a mobile phone, a game device, a video device, a Personal Digital Assistant (PDA), or the like, such a device can be configured to function as the information processing device 70 according to the present disclosure.

Furthermore, effects described in this specification are merely examples, effects are not limited thereto, and there may be other effects.

In addition, the present technology can employ the following configurations while remaining within the technical scope of the present disclosure.
(1) An imaging apparatus including:
circuitry configured to
acquire an input image from an image sensor,
generate information related to color conversion of the acquired input image based on
a first color setting parameter determined according to at least one first light source configured to provide illumination light for the acquired input image, and
a second color setting parameter determined according to at least one second light source configured to provide illumination light for the acquired input image, and
initiate output of output data according to the generated information related to color conversion of the acquired input image.
(2) The imaging apparatus according to (1), in which the at least one first light source includes one or more first lighting devices that display one or more background images in the acquired input image, and the at least one second light source includes at least one lighting device of a different light source type than the one or more first lighting devices.
(3) The imaging apparatus according to (1) or (2), in which the one or more first lighting devices include an arrangement of one or more light emitting diode (LED) panels that display the one or more background images.
(4) The imaging apparatus according to any of (1) to (3), in which content of the one or more background images is determined according to information indicating an area of the one or more LED panels included in the acquired input image.
(5) The imaging apparatus according to any of (1) to (4), in which the first color setting parameter is determined according to spectral characteristics of the at least one first light source, and the spectral characteristics of the at least one first light source are different from spectral characteristics of the at least one second light source.
(6) The imaging apparatus according to any of (1) to (5), in which the at least one first light source comprises one or more first lighting devices that display one or more background images in the acquired input image.
(7) The imaging apparatus according to any of (1) to (6), in which the first color setting parameter and the second color setting parameter are reflected in the color conversion according to a mixing ratio set between the first color setting parameter and the second color setting parameter.
(8) The imaging apparatus according to any of (1) to (7), in which the mixing ratio is set according to an operation of a user.
(9) The imaging apparatus according to any of (1) to (8), in which the mixing ratio is set according to a ratio of intensity of the illumination light provided by the at least one first light source to intensity of the illumination light provided by the at least one second light source.
(10) The imaging apparatus according to any of (1) to (9), in which the first color setting parameter and the second color setting parameter include at least one of color temperature or tint value of the acquired input image.
(11) The imaging apparatus according to any of (1) to (10), in which the generated information includes metadata corresponding to the first color setting parameter and the second color setting parameter.
(12) The imaging apparatus according to any of (1) to (11), in which the output data includes the metadata in an output image based on the acquired input image.
(13) The imaging apparatus according to any of (1) to (12), in which the output data includes at least one metadata file corresponding to the metadata, the at least one metadata file being separate from and associated with at least one output image file based on the acquired input image.
(14) The imaging apparatus according to any of (1) to (13), in which the output data includes raw image data.
(15) The imaging apparatus according to any of (1) to (14), in which the circuitry is further configured to perform color conversion based on the first color setting parameter and the second color setting parameter to obtain a color converted image included in the output data.
(16) The imaging apparatus according to any of (1) to (15), in which the output data includes the color converted image and raw image data.
(17) An image processing method including:
acquiring an input image;
generating information related to color conversion of the acquired input image based on a first color setting parameter determined according to at least one first light source configured to provide illumination light for the acquired input image, and a second color setting parameter determined according to at least one second light source configured to provide illumination light for the acquired input image; and
outputting output data according to the generated information related to color conversion of the acquired input image.
(18) The image processing method according to (17),
in which the acquiring includes acquiring the input image from another information processing apparatus, the first color setting parameter and the second color setting parameter are each acquired in association with the acquired input image, and the method further includes performing color conversion based on the acquired first color setting parameter and the acquired second color setting parameter to obtain a color converted image included in the output data.
(19) The image processing method according to (17) or (18), further including:
correcting at least one of the first color setting parameter and the second color setting parameter; and
associating the corrected first color setting parameter or the corrected second color setting parameter with raw image data.
(20) A non-transitory computer-readable medium having embodied thereon a program, which when executed by a computer causes the computer to execute an information processing method, the method including:
acquiring an input image;
generating information related to color conversion of the acquired input image based on a first color setting parameter determined according to at least one first light source configured to provide illumination light for the acquired input image, and a second color setting parameter determined according to at least one second light source configured to provide illumination light for the acquired input image; and
outputting output data according to the generated information related to color conversion of the acquired input image.

### REFERENCE SIGNS LIST

21 Image sensor
22 UI unit
23 Communication unit
24 Recording control unit
25 Control unit
26 Memory unit
27 Display unit
30 Signal processing unit
31 Sensor signal processing unit
32 White balance processing unit (WB processing unit)
33 Color separating unit
34 Matrix processing unit
35 Development processing unit
41, 41a, and 41b Coefficient setting unit
42, 43, 44 Multiplier
45 Coefficient setting unit
46 Matrix coefficient processing unit
47, 48 Blended coefficient setting unit
50 GUI display
51 Color temperature operator
52 Color temperature operator
53 Tint operator
54 Tint operator
55 Mixing ratio operator
70 Information processing device
71 CPU
90 Raw development software
92 White balance processing unit (WB processing unit)
94 Matrix processing unit
502 Camera
505 LED wall
580 Light

1. An imaging apparatus comprising:
circuitry configured to
acquire an input image from an image sensor,
generate information related to color conversion of the acquired input image based on
a first color setting parameter determined according to at least one first light source configured to provide illumination light for the acquired input image, and
a second color setting parameter determined according to at least one second light source configured to provide illumination light for the acquired input image, and
initiate output of output data according to the generated information related to color conversion of the acquired input image.

2. The imaging apparatus according to claim 1,
wherein the at least one first light source comprises one or more first lighting devices that display one or more background images in the acquired input image, and
wherein the at least one second light source comprises at least one lighting device of a different light source type than the one or more first lighting devices.

3. The imaging apparatus according to claim 2,
wherein the one or more first lighting devices include an arrangement of one or more light emitting diode (LED) panels that display the one or more background images.

4. The imaging apparatus according to claim 3,
wherein content of the one or more background images is determined according to information indicating an area of the one or more LED panels included in the acquired input image.

5. The imaging apparatus according to claim 1,
wherein the first color setting parameter is determined according to spectral characteristics of the at least one first light source, and
wherein the spectral characteristics of the at least one first light source are different from spectral characteristics of the at least one second light source.

6. The imaging apparatus according to claim 5,
wherein the at least one first light source comprises one or more first lighting devices that display one or more background images in the acquired input image.

7. The imaging apparatus according to claim 5,
wherein the first color setting parameter and the second color setting parameter are reflected in the color conversion according to a mixing ratio set between the first color setting parameter and the second color setting parameter.

8. The imaging apparatus according to claim 7,
wherein the mixing ratio is set according to an operation of a user.

9. The imaging apparatus according to claim 7,
wherein the mixing ratio is set according to a ratio of intensity of the illumination light provided by the at least one first light source to intensity of the illumination light provided by the at least one second light source.

10. The imaging apparatus according to claim 1,
wherein the first color setting parameter and the second color setting parameter include at least one of color temperature or tint value of the acquired input image.

11. The imaging apparatus according to claim 1,
wherein the generated information includes metadata corresponding to the first color setting parameter and the second color setting parameter.

12. The imaging apparatus according to claim 11,
wherein the output data includes the metadata in an output image based on the acquired input image.

13. The imaging apparatus according to claim 11,
wherein the output data includes at least one metadata file corresponding to the metadata, the at least one metadata file being separate from and associated with at least one output image file based on the acquired input image.

14. The imaging apparatus according to claim 1,
wherein the output data includes raw image data.

15. The imaging apparatus according to claim 1,
wherein the circuitry is further configured to perform color conversion based on the first color setting parameter and the second color setting parameter to obtain a color converted image included in the output data.

16. The imaging apparatus according to claim 15,
wherein the output data includes the color converted image and raw image data.

17. An image processing method comprising:
acquiring an input image;
generating information related to color conversion of the acquired input image based on
a first color setting parameter determined according to at least one first light source configured to provide illumination light for the acquired input image, and
a second color setting parameter determined according to at least one second light source configured to provide illumination light for the acquired input image; and
outputting output data according to the generated information related to color conversion of the acquired input image.

18. The image processing method according to claim 17,
wherein the acquiring includes acquiring the input image from another information processing apparatus,
wherein the first color setting parameter and the second color setting parameter are each acquired in association with the acquired input image, and
wherein the method further comprises performing color conversion based on the acquired first color setting parameter and the acquired second color setting parameter to obtain a color converted image included in the output data.

19. The image processing method according to claim 17, further comprising:
correcting at least one of the first color setting parameter and the second color setting parameter; and
associating the corrected first color setting parameter or the corrected second color setting parameter with raw image data.

20. A non-transitory computer-readable medium having embodied thereon a program, which when executed by a computer causes the computer to function as execute an information processing method, the method comprising:
acquiring an input image;
generating information related to color conversion of the acquired input image based on
a first color setting parameter determined according to at least one first light source configured to provide illumination light for the acquired input image, and
a second color setting parameter determined according to at least one second light source configured to provide illumination light for the acquired input image; and
outputting output data according to the generated information related to color conversion of the acquired input image.
